(19) United States
(12) Patent Application Publication
(10) Pub. No.: US 2020/0375221 A1
(43) Pub. Date: Dec. 3, 2020

(54) SYSTEMS, METHODS, AND COMPOSITIONS FOR MAKING A CARBONATED BEVERAGE

(71) Applicant: AQUASPARK, PBC, Alpine, UT (US)

(72) Inventors: Stephen Colvin, ALPINE, UT (US); Chandler Warr, ALPINE, UT (US)

(21) Appl. No.: 16/886,335

(22) Filed: May 28, 2020

Related U.S. Application Data
(60) Provisional application No. 62/968,088, filed on Jan. 30, 2020.
(60) Provisional application No. 62/854,099, filed on May 29, 2019.

(51) Int. Cl. A23L 2/40; A23L 2/56; A23L 2/60; A23L 2/68; A23L 27/12; A23L 33/155; A23L 2/39; A23L 29/00; B65D 47/12; B65D 85/73

(52) U.S. Cl. CPC A23L 2/40; A23L 2/56; A23L 2/60; A23L 2/68; A23L 27/12; A23V 2002/00; A23L 2/39; A23L 29/015; B65D 47/123; B65D 85/73; A23L 33/155

(57) ABSTRACT

A bottle for creating a carbonated beverage by combining an effervescent composition with an aqueous liquid disposed within the bottle includes an interior sidewall defining a cavity and a cavity opening, a removable lid configured to interface with and seal over the cavity opening (the removable lid having a spout), and a cap configured to form an airtight seal over the spout. The bottle is pressure-sealed when the removable lid seals the cavity opening and the cap seals the spout. Effervescent compositions can include about 41%-64% by weight of an acidic component, about 25%-51% by weight of carbonate or bicarbonate salts, less than about 15% by weight of one or more sweeteners or flavors, about 0.05%-1% by weight of an anticaking agent, and optionally less than about 2.5% by weight vitamin supplement, all weights based on a total weight of the composition.

### CROSS-REFERENCE TO RELATED APPLICATIONS

This application claims priority to and the benefit of U.S. Provisional Patent Application Ser. No. 62/854,099, filed May 29, 2019 and titled “SYSTEMS, METHODS, AND COMPOSITIONS FOR MAKING A CARBONATED BEVERAGE” and also claims priority to and the benefit of U.S. Provisional Patent Application Ser. No. 62/968,088, filed Jan. 30, 2020 and titled “SYSTEMS, METHODS, AND COMPOSITIONS FOR MAKING A CARBONATED BEVERAGE.” The foregoing applications are incorporated herein by this reference in their entirety.

### BACKGROUND

Carbonated beverages, such as carbonated water or soft drinks, contain dissolved carbon dioxide. CO₂ is often dissolved into a liquid in a pressurized environment, and sometimes the liquid is cooled to a low temperature in order for the CO₂ to more easily dissolve into the liquid.

When the pressure used to force the CO₂ into solution is reduced/released (or the temperature rises), the liquid effervesces as CO₂ falls out of solution, creating small bubbles. This occurs, for example, upon opening a container in which a carbonated beverage is stored. The effervescence can provide a satisfying and/or desirable sensation as a person drinks a carbonated beverage. After all of the CO₂ has effervesced from the carbonated beverage, the beverage loses its carbonated quality. Put differently, the once carbonated beverage becomes “flat.”

Carbonated beverages are typically made in a commercial carbonation plant, where high-pressure pumps provide CO₂ to a low-temperature beverage, producing a carbonated beverage that is then sealed and distributed. Many consumers, however, desire to create their own carbonated beverages. For example, a consumer may wish to make carbonated beverages that are not readily or commercially available, or they may wish to make a novelty carbonated beverage according to their personal taste.

Current home-use carbonation units inconveniently require the use of bulky CO₂ canisters or cartridges that have to be monitored and frequently replaced. Other potential solutions for non-commercial or at-home carbonation involve privately designed assemblies that include equipment such as CO₂ tanks and regulators, one-directional gas valves, complex carbonation caps, liquid containers, etcetera. Such potential solutions, however, suffer from a lack of portability and can be dangerous to operate or house.

Accordingly, there are a number of disadvantages in the field of making carbonated beverages that can be addressed.

### BRIEF SUMMARY

Disclosed embodiments include systems, methods, and compositions for making a carbonated beverage.

Embodiments of the present disclosure include effervescent compositions for creating a carbonated beverage. For example, an effervescent composition of the present disclosure includes (i) about 41%-64% by weight of an acidic component, (ii) about 25%-51% by weight of carbonate or bicarbonate salts, (iii) less than about 15% by weight of one or more sweeteners or flavors, (iv) about 0.05%-1% by weight of an anticaking agent, and (v) optionally less than about 2.5% by weight vitamin supplement, wherein all weights are based on a total weight of the composition.

In one aspect of the disclosed effervescent compositions, the carbonate or bicarbonate salts comprise about 4%-10% by weight calcium carbonate and about 21%-41% by weight of bicarbonate salts, based on the total weight of the composition.

In one aspect of the disclosed effervescent compositions, the carbonate or bicarbonate salts comprise about 5%-8% by weight calcium carbonate and about 28%-35% by weight of bicarbonate salts, wherein all weights are based on the total weight of the composition.

In one aspect of the disclosed effervescent compositions, the calcium carbonate has a particle size less than 1 μm, preferably between 0.5 μm-0.8 μm. In one aspect, the carbonate salt comprises about 5%-8% by weight magnesium carbonate, based on the total weight of the composition. In one aspect, the magnesium carbonate has a particle size smaller than 200 mesh and/or larger than 500 mesh, preferably between 270-325 mesh. In one aspect, the bicarbonate salts comprise about 12%-25% by weight potassium bicarbonate, preferably about 14%-17% by weight potassium bicarbonate, and about 13%-26% by weight sodium bicarbonate, preferably about 14%-17% by weight sodium bicarbonate, based on the total weight of the composition. In one aspect, the carbonate or bicarbonate salts comprises sodium bicarbonate having a particle size smaller than 25 mesh and/or larger than 100 mesh, preferably between 50-70 mesh.

In one aspect of the disclosed effervescent compositions, the acidic component comprises about 28%-37% by weight citric acid, preferably between about 30%-35% by weight citric acid, and about 13%-27% by weight malic acid, preferably between about 18%-22% by weight malic acid, based on the total weight of the composition. In one aspect, the citric acid has a particle size smaller than 100 mesh and/or larger than 200 mesh, preferably between 120-170 mesh, and wherein the malic acid has a particle size smaller than 750 μm and/or greater than 50 μm, preferably between 150 μm-710 μm.

In one aspect of the disclosed effervescent compositions, the one or more sweeteners or flavors comprise less than 7.5% by weight of a sweetener, preferably between 1%-3% by weight of the sweetener, and less than 10% by weight of one or more natural flavors, preferably between 2%-8% by weight of one or more fruit extracts, based on the total weight of the composition.

In one aspect of the disclosed effervescent compositions, the anticaking agent comprises about 0.1%-0.25% by weight silicon dioxide, based on the total weight of the composition.

In one aspect, the disclosed effervescent compositions include less than about 2.5% by weight vitamin supplement, the vitamin supplement comprising about 0.1%-0.3% by weight vitamin D and less than about 2.2% vitamin C, based on the total weight of the composition. In one aspect, the vitamin C comprises ascorbic acid having a particle size smaller than 10 mesh and/or larger than 50 mesh, preferably between 14-25 mesh.

Embodiments of the present disclosure additionally include systems for making a carbonated beverage. An exemplary system includes an effervescent composition disclosed herein and a bottle. The bottles disclosed herein can be included as part of the disclosed systems or can constitute separate and distinct embodiments of the present disclosure.

Whether alone or included in the aforementioned systems, at least one bottle of the present disclosure includes (i) an interior sidewall defining a cavity and a cavity opening, (ii) a removable lid configured to interface with and seal over the cavity opening, the removable lid comprising a spout, and (iii) a cap configured to form an airtight seal over the spout. The bottle is configured to be pressure-sealed when the removable lid is sealed over the cavity opening and the cap is sealed over the spout.

In one aspect, the removable lid comprises a channel formed by an exterior surface of the spout, the channel spanning a channel opening, a channel bend, and a channel end. The channel opening is positioned at a top of the spout and is configured to receive a protrusion of the cap and to allow the protrusion to advance from the channel opening to the channel bend, and the channel extends from the channel bend around at least a portion of the circumference of the spout in a downward-sloping fashion toward the channel end, such that the cap forms an airtight seal over the spout of the removable lid when the protrusion of the cap is advanced past the channel bend and toward the channel end. In one aspect, the channel comprises an indented section formed by an upper channel wall between the channel bend and the channel end, the indented section being configured to catch the protrusion of the cap as the protrusion retracts through the channel from the channel end toward the channel bend and is biased toward the upper channel wall. In one aspect, the indented section includes (a) a ramp section having a steeper slope than the upper channel wall positioned adjacent to and downstream of the ramp section, (b) a first wall coupled to the ramp section, and (c) a second wall transverse to—and coupled to—the first wall such that the second wall extends downward into the channel and is sized and shaped to (1) catch the protrusion as the protrusion retracts through the channel from the channel end toward the channel bend and is biased toward the upper channel wall, (2) allow the protrusion to pass back into the channel proximal of the indented section when the protrusion is biased toward the channel bend and toward a lower channel wall opposite the first wall.

In one aspect, the cavity opening of the bottle has a flat rim extending around a top of the cavity opening and an angled surface extending from an interior side of the flat rim sloping downward toward an interior sidewall of the cavity. In one aspect, the removable lid includes a gasket configured to interface with both the flat rim and the angled surface of the cavity opening to provide an airtight connection between the removable lid and the cavity. In one aspect, the gasket is positioned circumferentially around of the removable lid within a gasket channel extending around the removable lid, the gasket channel being formed around the removable lid between a radial protrusion extending radially from the removable lid and a shelf that surrounds the removable lid and opposes the radial protrusion. In one aspect, the shelf has an outer diameter that is smaller than an outer diameter of the radial protrusion.

In one aspect, the cavity opening has a diameter that is greater than a diameter of the spout of the removable lid.

In one aspect, the removable lid includes a channel disposed on an exterior of the spout, the channel comprising a first portion and a second portion. The first portion forms or includes a channel opening that is positioned at a top of the spout and is configured to receive a protrusion of the cap to allow the protrusion of the cap to advance through the channel, the first portion extending from the channel opening to a channel bend. The second portion extends from the channel bend around the exterior of the spout in a downward-sloping fashion toward a channel end, such that the cap forms an airtight seal over the spout of the removable lid when the protrusion of the cap is advanced through the channel toward the channel end. In one aspect, the protrusion of the cap advancing along the downward-sloping channel as the cap is tightened causes the opening formed by the spout to compress against a gasket disposed on an interior surface of the lid, thereby causing compression of the gasket and sealing of the cap with respect to the lid. In one aspect, the second portion includes an indented section in an upper channel wall of the second portion, the indent being configured to catch the protrusion of the cap as the protrusion retracts through the channel along the upper channel wall of the second portion. In one aspect, the first wall is orthogonal to the second wall.

In one aspect, the removable lid includes two or more channels disposed on the exterior of the spout.

In one aspect, the cap includes a pressure relief valve configured to selectively open to release pressure from the bottle when the pressure within the bottle meets or exceeds a threshold pressure (e.g., 100 psi, preferably about 60 psi). In one aspect, the pressure relief valve includes (i) a proximal flange connected to a distal flange by an elongate body, the elongate body extending through a pressure relief opening formed in the cap and having a smaller diameter than the pressure relief opening; (ii) a diaphragm positioned over the pressure relief opening of the cap and beneath the proximal flange, the diaphragm forming an airtight connection with the cap over the pressure relief opening when the pressure within the bottle is below the threshold pressure; and (iii) a spring arranged circumferentially around the elongate body and biased between the distal flange and an interior sidewall of the cap surrounding the pressure relief opening, the spring being configured to compress the proximal flange against the diaphragm and form the airtight connection at cavity pressures less than the threshold pressure. In one aspect, the spring has a stiffness calibrated such that at the threshold pressure, the spring is compressed between the distal flange and the interior sidewall of the cap surrounding the pressure relief opening at a distance to cause the pressure relief valve to open by extending the proximal flange away from the gasket, relieving the pressure within the cavity. In one aspect, the distance is less than 5 mm, preferably between about 1-3 mm. In an alternative aspect, the pressure relief valve include a split silicone diaphragm sized and shaped and having an elasticity such that the split silicone diaphragm is configured to vent above the threshold pressure.

In one aspect, the proximal flange and the diaphragm are the same component or are fused or welded such that the components operate as a single component.

In one aspect, the cavity is at least partially surrounded by an insulating layer. In one aspect, the insulating layer includes a vacuum or air compartment sandwiched between the sidewall forming the cavity and the sidewall forming the exterior shell of the bottle.

Embodiments of the present disclosure can additionally include methods for making a carbonated beverage, particularly where such methods include or utilize one or more of the foregoing (or other disclosed) embodiments of bottles and systems including the same.

An exemplary method for making a carbonated beverage includes placing an aqueous solvent within a cavity of a bottle through a cavity opening, securing a removable lid over the cavity opening, the removable lid comprising a spout, placing an effervescent composition through the spout into the aqueous solvent within cavity of the bottle such that the effervescent composition reacts with the aqueous solvent to release CO₂ gas, and sealing the cavity of the bottle by securing a cap over the lid such that the released CO₂ gas pressurizes the cavity of the bottle and dissolves into the aqueous solvent to form a carbonated beverage.

In one aspect, the method additionally includes automatically releasing pressure from the cavity by a spring-loaded pressure relief valve of the cap when the pressure within the cavity of the bottle meets or exceeds a threshold pressure.

In one aspect, sealing the cavity of the bottle by securing the cap over the lid includes inserting a protrusion of the cap into a channel by inserting the protrusion through a channel opening positioned at a top of the spout, advancing the protrusion through a first portion of the channel toward a channel bend, advancing the protrusion through the channel bend and through a second portion of the channel toward a channel end, the second portion of the channel having a downward slope.

In one aspect, the method additionally includes manually releasing pressure from the cavity by, as the protrusion is forced against an upper channel wall of the second portion by the pressure within the cavity of the bottle, retracting the protrusion through the second portion of the channel over an indented section in the upper channel wall of the section portion, causing the protrusion of the cap to be forced upward into the indented section to at least partially unseal the cap from the spout to release at least some of the pressure within the cavity of the bottle through the spout while retaining the protrusion of the cap within the indented portion. In one aspect, the method additionally includes removing the protrusion of the cap from the indented section, continuing to retract the protrusion through the second portion of the channel toward the channel bend, and retracting the protrusion through the channel bend, through the first portion of the channel, and through the channel opening.

One or more alternative bottles are envisioned within the scope of this disclosure and can be included as part of the disclosed systems or can constitute separate and distinct embodiments of the present disclosure, as above. In one aspect, a bottle for creating a carbonated beverage by combining an effervescent composition with an aqueous liquid held by the bottle can include an interior sidewall defining a cavity and a cavity opening, and a removable lid configured to secure over and seal the cavity opening. The removable lid can include an intermediate compartment selectively openable to the cavity and an actuator for selectively opening the intermediate compartment to the cavity.

In one aspect, the removable lid further includes a drink spout for accessing liquid within the cavity.

In one aspect, the actuator includes a button for mechanically displacing a barrier to selectively open the intermediate compartment to the cavity.

In one aspect, the bottle additionally includes an insert configured to hold at least a portion of the effervescent composition. In one aspect, the insert is a plastic or silicone insert having a depression for holding the effervescent composition, the depressing being accessible to the aqueous solution upon shaking or agitating the bottle.

In one aspect, the bottle further includes a pressure relief valve for releasing pressure from the cavity when the pressure within the cavity exceeds a threshold pressure. In one aspect, the pressure relief valve includes a split silicone diaphragm configured to vent above the threshold pressure. Alternatively, the pressure relief valve includes (i) a proximal flange connected to a distal flange by an elongate body, the elongate body extending through a pressure relief opening formed in the cap and having a smaller diameter than the pressure relief opening; (ii) a diaphragm positioned over the pressure relief opening of the cap and beneath the proximal flange, the diaphragm forming an airtight connection with the cap over the pressure relief opening when the pressure within the bottle is below the threshold pressure; and (iii) a spring arranged circumferentially around the elongate body and biased between the distal flange and an interior sidewall of the cap surrounding the pressure relief opening, the spring being configured to compress the proximal flange against the diaphragm and form the airtight connection at cavity pressures less than the threshold pressure.

In one aspect, the cavity is at least partially surrounded by an insulating layer. In one aspect, the insulating layer includes a vacuum or air compartment sandwiched between the sidewall forming the cavity and the sidewall forming the exterior shell of the bottle.

Embodiments of the present disclosure can additionally include methods for making a carbonated beverage, particularly where such methods include or utilize one or more of the foregoing (or other disclosed) embodiments of bottles and systems including the same.

An exemplary method for making a carbonated beverage includes the steps of placing an aqueous solvent within a cavity of a bottle, placing an effervescent composition within an intermediate compartment of a removable lid of the bottle, sealing the cavity of the bottle by securing the removable lid of the bottle over a cavity opening, and operating an actuator associated with the removable lid to selectively open the intermediate compartment to the cavity and release the effervescent composition into the aqueous solvent such that the effervescent composition reacts with the aqueous solvent to release CO₂ gas which pressurizes the cavity and dissolves into the aqueous solvent to form a carbonated beverage. In one aspect, the effervescent composition include at least one of the effervescent compositions disclosed and described herein.

In one aspect, operating the actuator includes compressing or activating a button for mechanically displacing a barrier to selectively open the intermediate compartment to the cavity.

In one aspect, the method additionally includes automatically releasing pressure from the cavity by a pressure relief valve of the bottle when the pressure within the cavity exceeds a threshold pressure.

Another exemplary method for making a carbonated beverage can include placing an aqueous solvent within a cavity of a bottle, placing an effervescent composition within an intermediate compartment associated with one or more of the bottle and a removable lid of the bottle, sealing the cavity of the bottle by securing the removable lid of the bottle over a cavity opening, and causing the effervescent composition to mix with the aqueous solvent.

In one aspect, causing the effervescent composition to mix with the aqueous solvent comprises agitating the bottle.

In one aspect, placing the effervescent composition within the intermediate compartment comprises loading the effervescent composition into an insert configured to allow the aqueous solvent to interact with the effervescent composition after sealing the bottle.

In one aspect, placing the effervescent composition within the intermediate compartment comprises loading the effervescent composition into a removeable silicone or plastic ring-shaped insert with a depression designed to hold at least a portion of the effervescent composition, preferably at least a portion of dry reactants of the effervescent composition. In one aspect, the insert is further configured to allow water to pass through and/or into the cavity formed by the insert and thereby mix with the effervescent composition.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

Additional features and advantages of the disclosure will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims or may be learned by the practice of the disclosure as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope.

The disclosure will be described and explained with additional specificity and detail through the use of the accompanying drawings in which:

FIGS. 1A and 1B illustrate a top view (FIG. 1A) of the cavity of an exemplary bottle for making a carbonated beverage and a side view of the exemplary bottle (FIG. 1B);

FIGS. 2A-2D illustrate various views of a lid of an exemplary bottle for making a carbonated beverage, namely a top left perspective view (FIG. 2a), a top view (FIG. 2B), a bottom view (FIG. 2C), and a side view with internal components illustrated in dashed lines (FIG. 2D);

FIG. 3 illustrates a system for making a carbonated beverage;

FIG. 4 illustrates a cross-sectional view of another exemplary bottle for making carbonated beverages;

FIG. 5 illustrates an exemplary flow diagram depicting acts associated with a method for making a carbonated beverage, according to the present disclosure;

FIGS. 6A and 6B illustrate views of another embodiment of a bottle for making a carbonated beverage, namely a perspective view (FIG. 6A) and a cross-sectional view (FIG. 6B);

FIGS. 7A-7C illustrate various views of the lid shown with the bottle assembly of FIGS. 6A and 6B; FIG. 7A illustrates a perspective view of the lid, FIG. 7B illustrates a front view of the lid, and FIG. 7C illustrates a side view of the lid;

FIGS. 8A and 8B respectively illustrate perspective and front, cross-sectional views of the cap shown with the bottle assembly of FIGS. 6A and 6B;

FIG. 9 illustrates a close-up cross-sectional view of the lid and cap in association with the bottle, as shown in FIGS. 6A and 6B; and

FIG. 10 illustrates an exemplary flow diagram depicting acts associated with a method for making a carbonated beverage, according to the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, any headings used herein are for organizational purposes only, and the terminology used herein is for the purpose of describing the embodiments. Neither are not meant to be used to limit the scope of the description or the claims.

### Overview

Carbonated beverages, such as carbonated water or soft drinks, contain dissolved carbon dioxide. CO₂ dissolved into water creates carbonic acid (H₂CO₃), according to the following reaction: H₂O(l)+CO₂ (g)↔H₂CO₃(aq). CO₂ is often dissolved into a liquid in a pressurized environment, and sometimes the liquid is cooled to a low temperature (e.g., just above freezing) in order for the CO₂ to more easily dissolve into the liquid (e.g., allowing the CO₂ to dissolve into the liquid under lower pressurization or at higher concentrations).

When the pressure used to force the CO₂ into solution is reduced/released (or the temperature rises), the liquid effervesces as CO₂ falls out of solution, creating small bubbles. This occurs, for example, upon opening a container in which a carbonated beverage is stored. The effervescence can provide a satisfying and/or desirable sensation as a person drinks a carbonated beverage. After all, or a substantial majority of, the CO₂ has effervesced from the carbonated beverage, the beverage loses its carbonated quality. Put differently, the once carbonated beverage becomes “flat.”

Carbonated beverages are typically made in a commercial carbonation plant, where high-pressure pumps provide CO₂ to a low-temperature beverage, producing a carbonated beverage that is then sealed and distributed. Many consumers, however, desire to create their own carbonated beverages that may not be readily or commercially available. For example, a consumer may wish to make a fruit soda out of locally grown fresh fruit or may desire to make novelty carbonated beverages.

Although some home-use carbonation units are commercially available (e.g., soda makers), such appliances are bulky, lack portability, and inconveniently require the use of multiple-use CO₂ canisters, which must be refilled, or single-use CO₂ cartridges. Aside from specialized commercial appliances, other methods for consumers to make carbonated beverages often involve privately designed assemblies which include equipment such as CO₂ tanks and regulators, one-directional gas valves, complex carbonation caps, liquid containers, etcetera. Privately designed assemblies, however, often also suffer from a lack of portability and can be dangerous to operate. For example, a liquid container in a privately designed system could explode if overly pressurized, or if inappropriate coupling elements are used in the system. Other non-commercial carbonators involve complicated machinery, expensive sparging units, and/or multiple chambers.

This disclosure includes embodiments that may address some or all of the aforementioned challenges with making carbonated beverages in non-commercial settings. In some embodiments, a system for creating a carbonated beverage includes an effervescent composition and a bottle. A sidewall of the bottle defines a cavity that can be selectively covered by a removable lid. When coupled to the bottle, the removable lid forms an airtight seal. The removable lid of the bottle includes an intermediate compartment for receiving an effervescent composition. The intermediate compartment is associated with an actuator that, when actuated, causes a barrier between the intermediate compartment and the bottle's cavity to be removed, thereby placing the intermediate compartment in fluid communication with the cavity. Accordingly, when the removable lid is secured over the cavity of the bottle to seal the cavity and the actuator is operated to release an effervescent composition stored within the intermediate compartment, the effervescent composition is released into the cavity. In some embodiments, the cavity contains an aqueous solvent (e.g., a beverage). The effervescent composition reacts with the aqueous solvent to form CO₂ gas which pressurizes the cavity and dissolves into the aqueous solvent to form a carbonated beverage.

Additionally, or alternatively, the bottle can be configured to receive a measure of an effervescent composition via an insert associated with the bottle. The insert can be, for example, a plastic or silicone (e.g., ring-shaped) device. The insert can be associated with the bottle such that it initially prevents direct association of the effervescent composition with the aqueous solvent in the bottle. In some embodiments, the insert can be housed in the opening of the bottle or otherwise accessible from the opening such that an effervescent composition can be received through the opening. Agitation of the sealed bottle can then enable mixing of the effervescent composition with the aqueous solvent.

In some embodiments, the effervescent composition can be configured for delayed release of one or more components of the composition. For example, one or more components of the composition may have a water-soluble coating (e.g., on the acidulants or on the bicarbonates) to slow the carbonates from releasing too much CO₂ (or too quickly releasing) at the beginning of the reaction. It should be appreciated that other chemical retardants or similar may be implemented in various embodiments.

In some embodiments, a bottle for creating a carbonated beverage by combining an effervescent composition with a liquid disposed within the bottle includes an interior sidewall defining a cavity and a cavity opening, a removable lid configured to interface with and seal over the cavity opening (the removable lid has a spout), and a cap configured for forming an airtight seal over the spout. The bottle is pressure-sealed when the removable lid is sealed over the cavity opening and when the cap is sealed over the spout. By having a separable lid and spout-covering cap, the user is afforded the benefit of more easily filling the cavity with an aqueous liquid (e.g., beverage) instead of attempting to aim the flow of the aqueous liquid through the narrower opening of the spout. It can additionally allow the user to more easily and conveniently place ice in the cavity.

Once the ice and/or beverage is within the cavity, the lid can be sealed thereto allowing the user to drink the contents thereof through the spout, which in some embodiments, is made of or includes an overlay of different material than the cavity and/or outer body of the bottle. This can include, for example, a silicone or other soft material that provides a less rigid and/or less conductive mouth-contacting surface. Such can benefit the user experience by decreasing a likelihood of injury or discomfort when imbibing the contents of the bottle.

Having a separable cap for sealing the spout can additionally provide the benefit of allowing for a pressurized cavity when sealed while still maintaining easy access to the bottle's contents. In some embodiments, the removable lid is engaged and disengaged by a quarter and/or half turn about the spout. A channel formed by an exterior surface of the spout can act to guide a protrusion in the cap through the channel opening and past a channel bend toward a channel end. The channel opening is positioned at a top of the spout and is configured to receive a protrusion of the cap and to allow the protrusion to advance from the channel opening to the channel bend. In an exemplary use, the user places the cap onto the spout by aligning the protrusion with the channel opening. Once aligned, gravity (or the user's downward force) drops the cap over the spout, and a sealing twist of the cap moves the protrusion past the channel bend and along the downwardly sloping channel. As the protrusion advances along the channel, it moves into tighter association with the upper channel wall, pressing the cap into (firmer) association with the spout opening. In some embodiments, the interior portion of the cap interfacing with the spout opening includes a gasket or seal. As the cap is drawn into closer association with the spout due to the traversal of the protrusion along the downwardly sloping channel, an airtight seal is formed between the cap and the spout.

The cap can be unsealed by reversing the advancement of the protrusion (e.g., counter rotating the cap) in the channel toward the channel bend. Once in the channel bend, the cap can be lifted off of the spout, pulling the protrusion through the channel and out of the channel opening.

In some embodiments, the cavity is pressurized. As the cap is unsealed, the pressure can be released. To prevent the cap from being ejected by the released pressure, the channel can include a indented region formed in the upper channel wall downstream of the channel bend. As the cap is removed, any upward pressure (e.g., by the user or cavity pressure against the cap) causes the protrusion to fall into the indented region of the channel. The indented region has a wider diameter than upstream and downstream portions of the channel and includes a wall transverse to the direction of the protrusion movement during removal of the cap. The pressure from the cavity can be released when the protrusion enters the indented region. As such, the cap is prevented from rapid advancement along the channel in the presence of an upward force, such as that caused by pressure within the cavity, beneficially preventing the cap from inadvertently being shot off the spout by the force of released pressure. In some embodiments, the absence of pressure from the cavity (whether none/negligible to begin with or after venting) causes the protrusion to fall toward the lower channel wall where it is no longer obstructed by the transverse wall of the indented region. The cap can then be removed from the spout by guiding the protrusion along the channel, past the channel bend, and through the channel opening.

Additional, or alternative, venting means are provided herein. It should be appreciated that when making a carbonated beverage, the pressure may exceed a safe threshold. For example, a user may make a carbonated beverage and leave the pressurized bottle in a hot vehicle, causing an increase in the internal pressure of the bottle. Without a means for venting the pressure when it exceed a threshold, the bottle may catastrophically fail, causing injury or damage. In some embodiments, the disclosed bottles can include a simple mechanical vent or pressure relief valve. For example, a split silicone diaphragm can be used where the type of silicone is selected (and the diaphragm sized) such that the elasticity of the material causes separation of the seal formed by the split diaphragm at a threshold pressure.

A split silicone diaphragm may fail over time with repeated use and washing of the lid/cap. In some embodiments, a pressure relief valve can include a spring-loaded valve. Such a valve can include proximal and distal flanges separated by an elongate body. The elongate body can extend through a vent or opening in the cap and have a gasket or seal disposed about the elongate body and positioned between the proximal flange and the vent/opening. The spring is wrapped circumferentially about the elongate body and biased between the distal flange and the interior portion of the cap surrounding/forming the vent/opening. As the pressure increases in the cavity, the distal flange presses against the spring, compressing it. This, in turn, causes the elongate body to traverse the opening, pushing the proximal flange away from the seal/gasket. With enough movement (e.g., enough pressure exerted on the distal flange), the seal between the proximal flange and the gasket/seal is broken, causing the pressure within the cavity to vent. Such mechanical pressure valves are disclosed herein and can be beneficial for maintaining a desired upper pressure threshold within the bottle cavity and/or for preventing catastrophic failure of one or more components of the bottle.

Various methods for making a carbonated beverage are disclosed herein and can use one or more of the effervescent compositions disclosed herein and/or one or more of the bottles disclosed herein. Preferably, the disclosed methods are employed using a disclosed system that includes one or more disclosed effervescent compositions and one or more disclosed bottles.

In some embodiments, a method for making a carbonated beverage includes placing an aqueous solvent within a cavity of a bottle through a cavity opening, securing a removable lid over the cavity opening, the removable lid comprising a spout, placing an effervescent composition through the spout into the aqueous solvent within cavity of the bottle such that the effervescent composition reacts with the aqueous solvent to release CO₂ gas, and sealing the cavity of the bottle by securing a cap over the lid such that the released CO₂ gas pressurizes the cavity of the bottle and dissolves into the aqueous solvent to form a carbonated beverage.

Those skilled in the art will recognize that, in some instances, the embodiments disclosed herein provide significant benefits over conventional systems and methods for making carbonated beverages in non-commercial settings. For example, some disclosed embodiments provide users with a highly safe and portable system for turning any beverage into a carbonated beverage, while also eliminating the need for a CO₂ canister, cartridge, or tank.

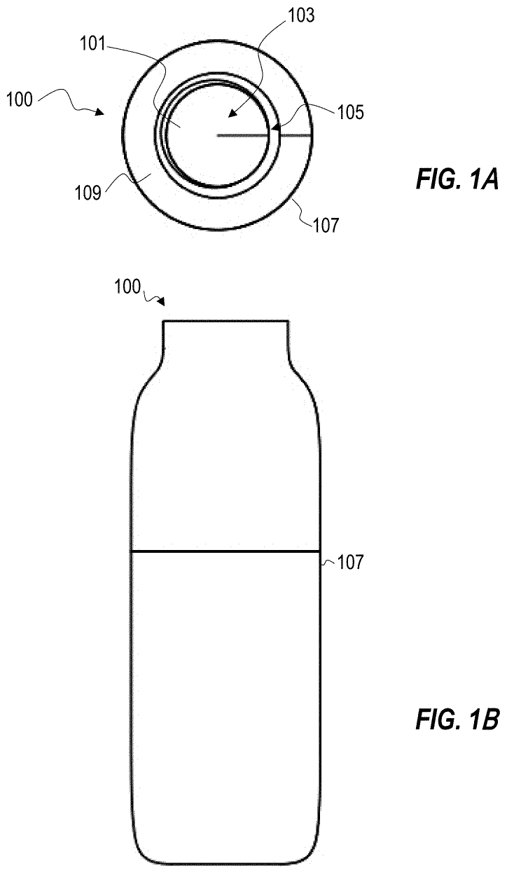

Having just described some of the various high-level features and benefits of the disclosed embodiments, attention will now be directed to FIGS. 1-10. These figures illustrate various functionalities, examples, supporting illustrations, and methods related to making a carbonated beverage, according to the embodiments described herein.

### Systems for Making a Carbonated Beverage

A system for making a carbonated beverage, according to the present disclosure, includes a bottle and an effervescent composition.

Referring now to FIGS. 1A and 1B, various views of a cavity or bottom portion of an exemplary bottle 100 for making a carbonated beverage are shown. The exemplary bottle 100 includes an interior sidewall 101 which defines a cavity 103. Cavity 103 is manufactured to hold any liquid, such as an aqueous solvent or beverage, that a consumer wishes to carbonate. For example, a consumer could place water, juice, tea, coffee, alcoholic drinks, or any other beverage into cavity 103.

The interior sidewall 101 further defines an opening 105 of the bottle 100. The opening 105 provides access to cavity 103 for inserting and removing liquids from cavity 103. Although opening 105 is shown with threads for receiving a removable lid to seal cavity 103, those skilled in the art will appreciate that other apparatuses for receiving a lid are possible, such as latch and clasp, lock and channel, press-fit, or friction-fit systems.

The bottle 100 additionally includes an exterior sidewall 107 that defines the outside of the bottle 100 and is spaced apart from the interior sidewall 101 such that an insulating layer 109 is disposed between the exterior sidewall 107 and interior sidewall 101. As such, the cavity 103 is at least partially surrounded by an insulating layer 109, and cavity 103 is therefore insulated. It will be recognized that insulating layer 109 can be a vacuum-insulated layer or be composed of any insulating material disposed between interior sidewall 101 and exterior sidewall 107.

In some instances, an insulated cavity can facilitate a more efficient carbonation process for making a carbonated beverage, in particular because, under lower temperatures, CO₂ gas can more easily dissolve into water (or nearly any aqueous solvent) and/or dissolve into an aqueous solvent at a higher concentration. Accordingly, if a low-temperature beverage is placed into cavity 103, the insulating layer 109 will aid in maintaining the low temperature of the beverage, which will allow CO₂ gas to dissolve into the beverage under lower pressure than would be necessary if the beverage was placed into cavity 103 at a higher temperature or if the temperature of the beverage was allowed to more rapidly rise (e.g., if cavity 103 was not at least partially surrounded by an insulating layer 109).

As used herein, the term “lower temperature” or “low temperature” is intended to include those temperatures at the freezing point of water to room temperature, or between 0-25° C., preferably between 0-15° C., more preferably between 0-10° C.

However, those skilled in the art will recognize that it is not necessary in all embodiments for the bottle 100 to be insulated, and that, in some embodiments, the exterior sidewall 107 and interior sidewall 101 are opposite sides of the same sidewall (e.g., there is no dedicated insulating layer between exterior sidewall 107 and interior sidewall 101).

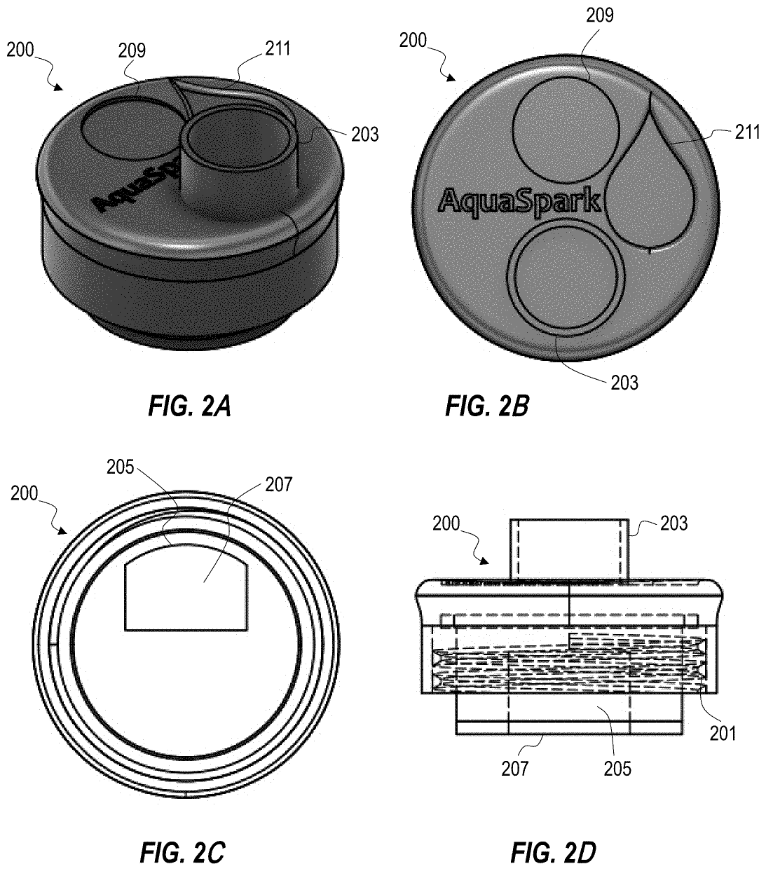

Attention is now directed to FIGS. 2A-2D, which illustrate a top left perspective view (FIG. 2a), a top view (FIG. 2B), a bottom view (FIG. 2C), and a side view with internal components illustrated in dashed lines (FIG. 2D) of a removable lid 200 of an exemplary bottle for making a carbonated beverage. As shown, removable lid 200 is configured to secure over and seal the cavity 103 of the bottle 100 by threads 201 that are manufactured to screw into the threads of opening 105 of the bottle 100. It should be noted that removable lid 200 can from an airtight seal with the bottle 100 and can include a gasket or other device to assist and/or principally enable the cavity 103 become pressure-sealed when lid 200 is secured over opening 105.

As shown, removable lid 200 also includes a drink spout 203, which provides a path from a top of removable lid 200 to the bottom of removable lid 200 such that drink spout 203 provides a way of accessing any liquid or beverage disposed within cavity 103 when removable lid 200 is secured over cavity 103. Drink spout 203 is selectively openable. For example, drink spout 203 can include rotatable elements, a second separately removable lid, a pushbutton opening mechanism, or other devices for selectively opening drink spout 203.

It will be appreciated, however, that removable lid 200 need not include a drink spout 203, and that any contents of cavity 103 may be accessed by simply removing removable lid 200 from opening 105.

When present, the drink spout contains a closing means that allows the removable lid to maintain an airtight seal over the bottle when the drink spout is in a closed position.

Removable lid 200 also includes an intermediate compartment 205, which is configured in size and position to receive and hold an effervescent composition (e.g., an effervescent tablet or powdered composition—such as that held in individual serving sizes like in a stick pack or similar) and subsequently release the effervescent composition into cavity 103 (e.g., after removable lid 200 is fastened to the bottle 100). Intermediate compartment 205 is positioned on the bottom of removable lid 200, such that when removable lid 200 is secured over and seals cavity 103, an effervescent composition stored within intermediate compartment 205 can be dropped or released into cavity 103 to combine with any liquid situated within cavity 103 in a pressure-sealed environment. Intermediate compartment 205 is thus selectively openable to cavity 103 when removable lid 200 is secured over cavity 103.

To facilitate this functionality, in the embodiment depicted, intermediate compartment 205 includes an openable barrier 207 and an actuator (implemented as button 209). Button 209 is mechanically coupled to barrier 207 such that barrier 207 is movable from a closed position to an open position (and, in some embodiments, vice versa) by operating (e.g., pushing) button 209. Thus, an effervescent composition may be placed within intermediate compartment 205 by opening barrier 207 (e.g., by manually displacing barrier 207 to access intermediate compartment 205 or by pushing button 209 to mechanically displace barrier 207). Once the effervescent composition is secured in intermediate compartment 205, removable lid 200 may be secured over cavity 103 to create an airtight seal with cavity 103. Subsequently, a consumer may operate button 209 to open barrier 207 and selectively open intermediate compartment 205 to cavity 103 and release the effervescent composition into cavity 103 so that the effervescent composition may interact with a beverage within the pressure-sealed environment of cavity 103.

In some embodiments, intermediate compartment is only accessible from the bottom of removable lid 200. In other embodiments, intermediate compartment is accessible from the top of removable lid 200 and the bottom of removable lid 200. For example, the intermediate compartment may be aligned with drink spout 203, such that the intermediate compartment forms a part of the path from the top of removable lid 200 to the bottom of removable lid 200. In such embodiments, the intermediate compartment is selectively openable to both the bottom and the top of the removable lid 200.

In some embodiments, the intermediate compartment is only accessible when the lid is dissociated from the bottle. The effervescent tablet or other form of composition (e.g., bulk powder or in the form of individual serving size like a stick pack) can be loaded into the intermediate compartment and upon sealing the bottle with the removable lid, the barrier automatically opens (e.g., tightening the removable lid over the opening of the bottle causes a conformational change in a portion of the lid, causing the intermediate compartment to open.

Although the actuator for manipulating the position of barrier 207 is depicted in FIG. 2 as a button 209, those skilled in the art will recognize that other kinds of actuators are within the scope of this disclosure, such as rotatable knobs, levers, switches, or any other mechanical device for displacing a barrier or other holding mechanism.

Furthermore, it will be appreciated that although the compartment for holding the effervescent composition while the removable lid 200 is being sealed over cavity 103 is illustrated in FIG. 2 as an intermediate compartment (e.g., a compartment that defines a volume), it should be noted that other formats may be used to temporarily fix the position of the effervescent composition to keep it separate from a liquid in cavity 103 until cavity 103 is in a pressure-sealed state. For example, one or more biasing members may be used to hold the effervescent composition in place (e.g., against another biasing member or against a part of the removable lid or bottom portion) or a space for friction fitting the effervescent composition to the lid may be used.

In yet other embodiments, an actuator is not used to displace a barrier or otherwise release an effervescent composition into a liquid contained within cavity 103. Rather, in such other embodiments, a device is used (e.g., intermediate compartment, biasing or threading members, friction fitting space, etc.) only to hold the effervescent composition in place while the removable lid is secured over cavity 103. Subsequently, a consumer rotates the system (e.g., turns the bottle over) to allow a liquid disposed within cavity 103 to react with the effervescent composition, without operating an actuator to change the position of the effervescent composition with respect to the device used to hold the effervescent composition in place. In such an embodiment, the effervescent composition begins to shrink in size as it reacts with the aqueous solvent. Upon tipping the bottle upright, the effervescent tablet will have shrunken in size and the pressure exerted on the effervescent tablet by the biasing members will be reduced or eliminated, thereby allowing it to fall into the aqueous solution.

In some embodiments, the effervescent composition can be configured for delayed release of one or more components of the composition. For example, one or more components of the composition may have a water-soluble coating (e.g., on the acidulants or on the bicarbonates) to slow the carbonates from releasing too much CO₂ (or too quickly releasing) at the beginning of the reaction. It should be appreciated that other chemical retardants or similar may be implemented in various embodiments.

As shown, removable lid 200 also includes a pressure relief valve 211. As the effervescent composition reacts with an aqueous solvent in cavity 103, CO₂ gas is released, which increases the pressure in cavity 103. In some instances, the high pressures caused by the reaction can prove dangerous (e.g., the bottle could explode). Thus, pressure relief valve 211 is configured to automatically release pressure from cavity 103 when the pressure within the cavity exceeds a threshold pressure.

Those skilled in the art will appreciate that certain elements described hereinabove as being part of the removable lid of the bottle can also be implemented as part of the bottom or cavity portion of the bottle. For example, the pressure relief valve, intermediate compartment (or other securing device/mechanism), and/or actuator may be implemented as part of the bottom/cavity portion of the bottle rather than as part of the removable lid of the bottle.

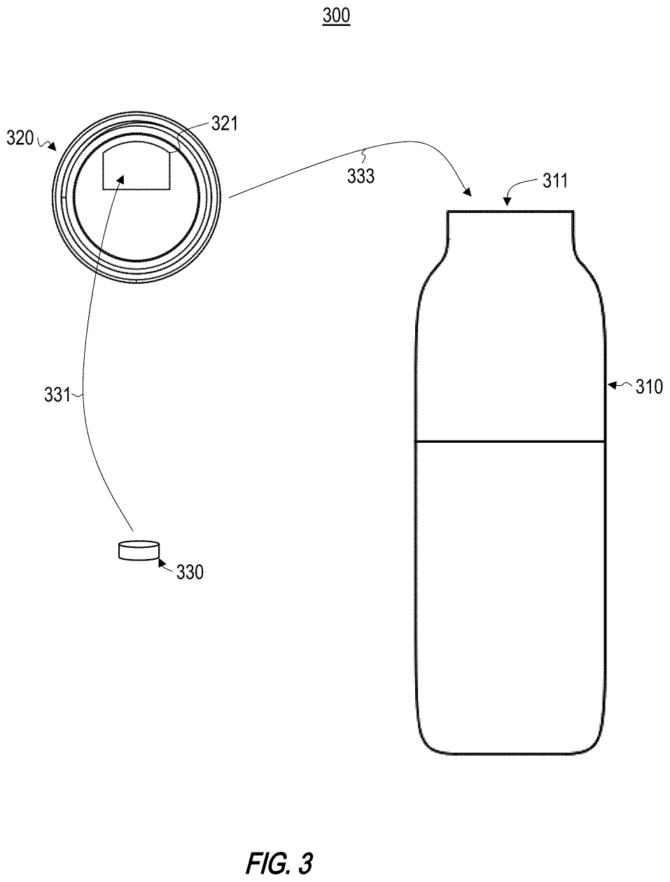

FIG. 3 illustrates a system 300 for making a carbonated beverage which includes a bottom portion 310 of a bottle, a removable lid 320 of a bottle, and an effervescent composition 330, shown in the form of a tablet (although it should be appreciated that the effervescent composition could also be in the form of a granulated solid or powder). Removable lid 320 is configured to fit over and seal a cavity 311 of bottom portion 310 (e.g., by a threaded connection with a gasket for sealing the cavity 311), and removable lid 320 also includes an intermediate compartment 321 which is selectively openable to the cavity 311 of bottom portion 310 when removable lid 320 is positioned over bottom portion 310.

Utilizing system 300, a consumer can carbonate beverage or other aqueous solvent disposed within cavity 311 of bottom portion 310 by placing effervescent composition 330 within intermediate compartment 321 (as denoted by arrow 331), sealing cavity 311 by securing removable lid 320 over bottom portion 310 (as denoted by arrow 333), and operating an actuator (or rotating/shaking the entire system 300)—or otherwise adding the composition to the solvent—causing the effervescent composition to merge with the aqueous solvent to cause the effervescent composition to react with the beverage or other aqueous solvent disposed within cavity 311. As effervescent composition 330 reacts with the beverage or aqueous solvent, CO₂ gas is released, which pressurizes cavity 311. As the pressure increases, the CO₂ gas dissolves into the beverage or aqueous solvent to carbonate the beverage or aqueous solvent. A user may then access the carbonated beverage or aqueous solvent by a drink spout of removable lid 320 or by removing removable lid 320 from bottom portion 310.

It should be noted that, in some instances, if the beverage disposed within cavity 311 is cooled to a low temperature and the low temperature is maintained (e.g., by utilizing a cavity that is at least partially surrounded by an insulating layer, and/or an insulated lid), more CO₂ gas will dissolve into the beverage disposed within cavity 311 as the effervescent composition 330 reacts with the beverage, producing improved carbonation results.

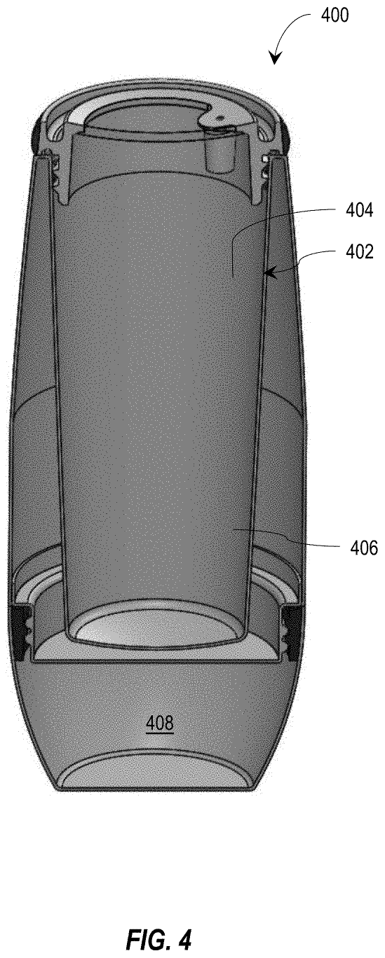

Additional embodiments of bottles for use in carbonating a beverage are depicted in FIGS. 4 and 6-9. Referring to FIG. 4, illustrated is a cross-sectional view of a bottle 400 for use in carbonating a beverage. As shown, the bottle 400 is double walled, which can be advantageous for maintaining the temperature of the beverage or aqueous solvent stored within the bottle.

As further shown in FIG. 4, the bottle may additionally include a removable bottom portion 408. The removable bottom portion 408 can be used, for example, for storing effervescent compositions (e.g., in the form of tablets, stick packs, or bulk powder). This can beneficially enable a user to mix a beverage on the go and can allow the user to choose a flavor or type of effervescent composition more quickly and/or easily.

Additionally, or alternatively, the removable bottom 408 can be used to store any other object sized and shaped to fit within the bottom portion. For example, a user may store their keys, headphones, (digital or physical) currency, gym pass and/or any other object they desire (and which is sized and shaped to fit within the bottom portion) for temporary safe keeping and/or to reduce the number of items they have to separately carry. A user may take the bottle with them to a remote workout (or travel) area and use the bottom portion to store their keys so as to reduce the likelihood they are lost or stolen. For example, a user may store their keys or other object in the bottom portion while at the beach or while hiking. A user may also use the bottom portion to store a gym pass or other membership credential typically used at or around the same time as the bottle.

The bottle 400 may additionally be configured to receive a measure of an effervescent composition via an insert (not shown) associated with the bottle 400. The insert can be, for example, a plastic or silicone (e.g., ring-shaped) device. The insert 402 can be associated with the bottle 400 such that it initially prevents direct association of the effervescent composition with the aqueous solvent in the bottle. In some embodiments, the insert can be housed in the opening of the bottle or otherwise accessible from the opening such that an effervescent composition can be received through the opening. Agitation of the sealed bottle can then enable mixing of the effervescent composition with the aqueous solvent.

In some embodiments, the insert includes a depression or otherwise defines a chamber configured to hold at least a portion of the effervescent composition. In some embodiments, the depression or chamber is configured in size and shape to accommodate a single serving size of the effervescent composition. In some embodiments, the depression or chamber is larger (e.g., 1% larger, 5% larger, 10% larger, or 20% larger). The depression or chamber can be configured such that the aqueous solvent can pass through the chamber. In such an embodiment, the chamber may be permeable to water and/or have a plurality of holes (e.g., a mesh) throughout the insert and/or positioned at particular locations on the insert, such as along the top and/or bottom of the insert. Additionally, or alternatively, the insert is further configured to allow water to pass into the cavity formed by the insert and thereby mix with the effervescent composition when the bottle is sealed and agitated.

In one embodiment, the insert includes a flap that remains closed when loaded with the dry effervescent composition, but which opens upon mixing with the aqueous solvent. The flap may be, for example, held by a living hinge, or similar, that is configured to open when the weight of the aqueous solvent is added but remains mostly or entirely closed under the weight of the loaded effervescent composition. Alternatively, the flap may be mechanically opened during agitation (e.g., the force of agitating the aqueous solvent causes the flap to deform and open and/or reiteratively open and close.

In one embodiment, the insert comprises a silicone or plastic ring-shaped insert that fits around the opening of the cup and includes a depression on one side and/or in the middle of the insert and an opening or openings that allow for liquid to pass out of the cup (e.g., when the user is drinking). The depression in the silicone or plastic ring can be designed to allow the cup to be filled with liquid, and after filling, provide a place for the dry reactants (e.g., the effervescent composition) to be poured without falling into the liquid, until such time that the user can close the lid of the cup. Once the lid is closed, the cup can then be shaken or otherwise agitated, which will allow the reactants to mix with water and form carbon dioxide. Openings on the bottom of the depression can be large enough to allow liquids to drain from the depression, but small enough that the dry reactants cannot fall through.

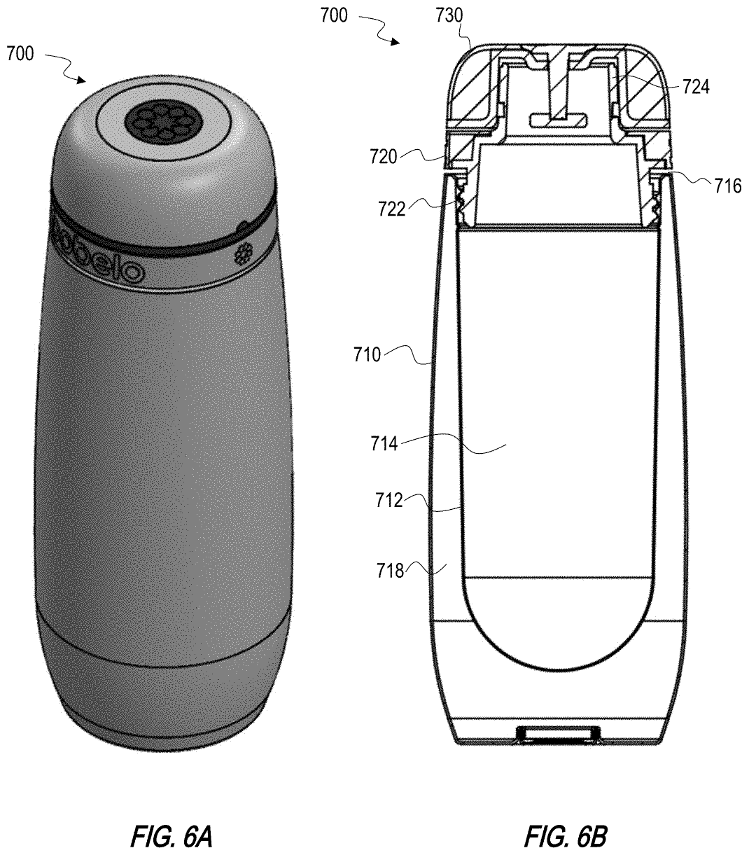

Much of the foregoing description and associated figures have focused on embodiments and/or implementations in which the effervescent composition is brought into contact with the aqueous solvent after the cavity or container housing the aqueous solvent is sealed, such as by actuating an actuator to open an intermediate compartment, or by shaking the sealed container to bring the aqueous solvent into contact with the effervescent composition being held/suspended within the sealed container. However, it should be noted that other compact systems and/or apparatuses for bringing an aqueous solvent into contact with an effervescent composition to create a carbonated beverage are within the scope of this disclosure. FIGS. 6-6 show supporting illustrations associated with alternative embodiments for a bottle system for creating a carbonated beverage.

Referring now to FIGS. 6A and 6B, illustrated perspective (FIG. 6A) and cross-sectional (FIG. 6B) views of another embodiment of a bottle 700 for making a carbonated beverage. The bottle 700 includes various elements, including a bottle cavity 710, a removable lid 720, and a cap 730. Similar to the bottle shown and described hereinabove with reference to other figures, the bottle cavity 710 includes an interior sidewall 712 that defines a cavity interior 714 of the bottle and a cavity opening 716. The cavity interior 714 is, in some embodiments, at least partially surrounded by an insulating layer 718. The cavity interior 714 may house an aqueous solvent for reacting with an effervescent composition to produce a carbonated beverage, as described herein.

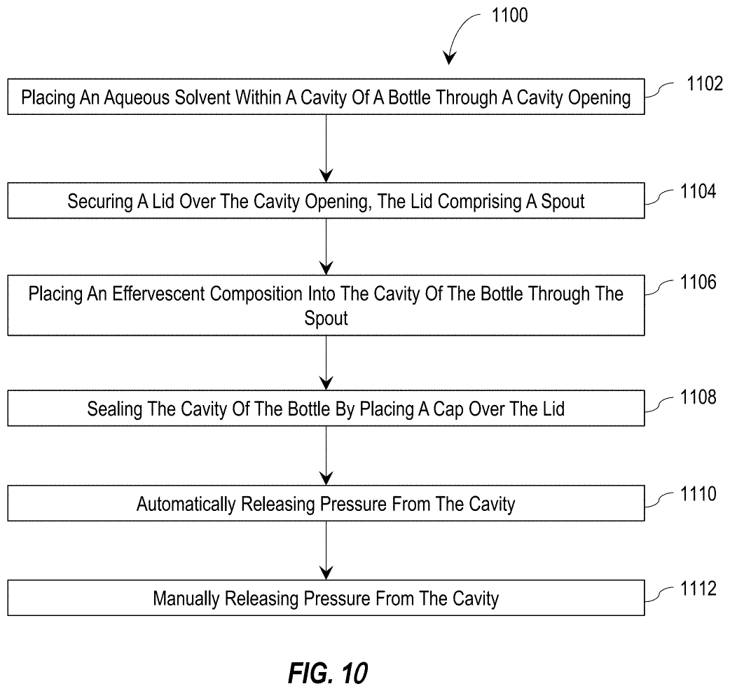

The removable lid 720 of the bottle 700 includes threads 722 that may thread into corresponding threads of the bottle cavity 710 that are proximate to the cavity opening 716, allowing the removable lid to interface with and seal over the cavity opening 716. When the threads 722 of the removable lid 720 are threaded into the threads of the bottle cavity 710, the removable lid 720 may form an airtight interface with the cavity opening 716. Additional details concerning the airtight connection between the removable lid 720 and the cavity opening 716 are described herein with reference to FIG. 10.

The removable lid 720 of the bottle 700 also includes a spout 724 extending from the top of the removable lid 720. As shown, the spout 724 has a diameter that is smaller than the diameter of the cavity opening 716 of the bottle cavity 710. Many users consider narrow spouts to be desirable for drinking liquids from bottles and consider wider openings to be desirable for inserting liquids and/or solids into bottles (e.g., to reduce spilling and/or allow entry of large solids, such as cubed ice). For example, a user may desire to put cubed ice into a bottle along with an aqueous solvent to form a carbonated beverage within the bottle using an effervescent solution, and the user may desire to drink the carbonated beverage directly from the same bottle. A bottle with only a narrow spout may provide a desirable drinking configuration but may fail to allow entry of cubed ice and may make it more difficult to pour an aqueous solvent into the bottle. In contrast, a bottle with only a wide opening may allow for entry of ice and easy pouring of aqueous solvents into the bottle but may fail to provide a desirable drinking configuration. Thus, the various parts of the bottle 700 may be configured to advantageously provide access to the cavity interior 714 of the bottle cavity 710 through differently sized openings, allowing the bottle 700 to provide a narrow spout 724 for a desirable drinking configuration and a wide cavity opening 716 for allowing easy entry of liquids and/or solids.

The cap 730 of the bottle 700 is configured to form an airtight seal over the spout 724. Accordingly, the bottle 700 may reach a sealed state for creating a carbonated beverage therein when the removable lid 720 is sealed over the cavity opening 716 and the cap 730 is sealed over the spout. The cap 730 may also include a pressure relief valve to prevent the pressure within the bottle (when sealed) from reaching unsafe levels. Additional details of the pressure relief valve will be described hereinbelow with reference to FIG. 10.

As described hereinabove, an effervescent composition may react with an aqueous solvent to form a carbonated beverage, particularly when the effervescent composition reacts with the aqueous solvent within a pressure-sealed cavity. However, an effervescent composition may begin reacting with the aqueous solvent to release CO₂ gas as soon as the effervescent composition comes into contact with the aqueous solvent. Unless the vessel within which the aqueous solvent reacts with the effervescent composition is in a pressure-sealed state when the aqueous solvent comes into contact with the effervescent composition, CO₂ gas released by the reaction will disperse into the atmosphere rather than dissolve into the aqueous solvent to form the carbonated beverage. Accordingly, a bottle in which a carbonated beverage will be created, according to the present disclosure, should become pressure-sealed before or as soon as possible after the effervescent composition comes into contact with the aqueous solvent.

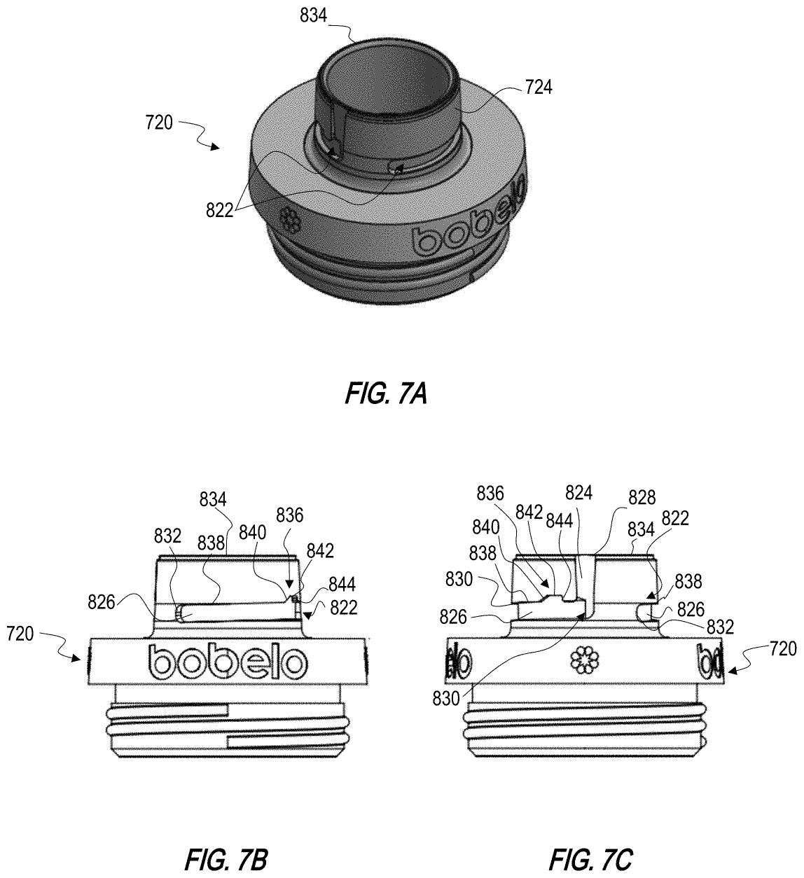

As will now be described with reference to FIGS. 7-9, the removable lid 720 and the cap 730 of the bottle 700 may include features that allow a user (with the removable lid 720 sealed over the cavity opening 716 of the bottle cavity 710) to insert an effervescent composition through the spout 724 into to contact with an aqueous solvent disposed within the bottle cavity 710 and then quickly seal the cap 730 over the spout 724 to pressure-seal the bottle 700 so that CO₂ gas released by the effervescent reaction remains within the bottle 700 to dissolve into the aqueous solvent to form a carbonated beverage within the bottle 700.

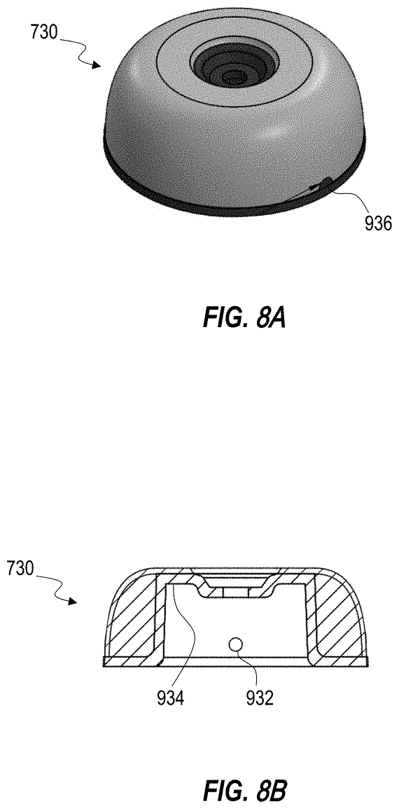

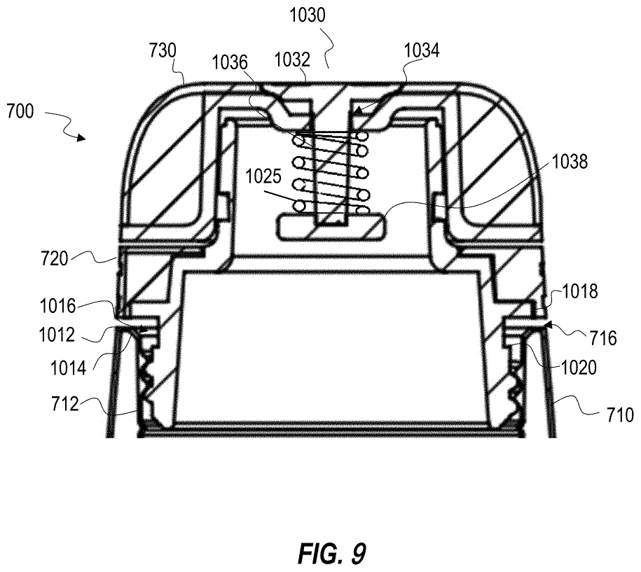

FIGS. 7A-7C illustrate a perspective view (FIG. 7A), a front view (FIG. 7B), and a side view (FIG. 7C) of the removable lid 720 of the bottle 700. The spout 724 of the removable lid 720 includes channels 822 disposed on the exterior portion of the spout 724. The channels 822 are configured to receive corresponding protrusions 932 of the cap 730 (see FIGS. 8A and 8B) to allow the protrusions 932 to advance through the channel 822. The cap 730 forms an airtight seal with the spout 724 when the protrusions 932 of the cap 730 advance sufficiently through the channels 822 of the removable lid 720, as will be described in more detail. The removable lid 720 shown in FIGS. 8A, 8B, and 9 has two channels 822 on opposing sides of the spout 724 configured to receive two corresponding protrusions 932 of the cap 730. However, those skilled in the art will recognize that a removable lid 720 may include any number of channels 822 for receiving corresponding protrusions 932 of the cap 730. For instance, a removable lid 720 may include a single channel 822 or three or more channels arranged equidistant from one another around the spout 724.

As shown in FIGS. 7A-7C, the channels 822 include a first portion 824 and a second portion 826, each extending in different directions. The first portion 824 of the channels 822 includes a channel opening 828 at the top of the spout 724 that opens upward from the spout 724. The protrusions 932 of the cap 730 may be inserted through the channel opening 828 of the first portion of the channels 822 to begin advancing through the channels 822. The first portion 824 of the channels 822 extends from the channel opening 828 downward in a substantially vertical path toward a channel bend 830 where the first portion 824 of the channels 822 meet the second portion 826 of the channels 822.

The second portion 826 of the channel 822 extends from the channel bend 830 around the exterior of the spout 724 toward a channel end 832. The second portion 826 of the channels 822 extend around the spout 724 in a substantially horizontal, downward-sloping fashion such that as the protrusions 932 of the cap 730 advance through the second portion 826, a seal 934 of the cap 730 (see FIG. 9) forces against a seal 834 of the spout 724 to form an airtight interface between the cap 730 and the spout 724.

In this regard, a user may quickly seal the cap 730 over the spout 724 of the removable lid 720 after inserting an effervescent composition (e.g., in tablet and/or powdered form) through the spout 724 by aligning the protrusions 932 of the cap with the channel opening 828 of the channels 822 and advancing the protrusions along the first portion 824, the channel bend 830, and the second portion 826 of the channels 822 toward the channel end 832 to force the cap 730 into an airtight connection with the spout 724 as the seals 834, 934 are forced together (e.g., by virtue of the downward-sloping direction of the second portion 826).

In some instances, a user may perform the foregoing acts in a single quick and/or fluid motion. Furthermore, in some instances, the user utilizes an effervescent composition that is in powdered form and pours the effervescent composition from a package, container, or bag that is conveniently sized to fit within the diameter of the spout 724 to enable accurate and quick disposal of the effervescent powder into the bottle cavity 710 through the spout 724. Accordingly, in at least some instances, although the effervescent reaction between the effervescent composition and an aqueous solvent may initially begin to release CO₂ gas into the atmosphere after the effervescent composition descends through the spout 724 into an aqueous solvent, a user may quickly pressure-seal the bottle 700 by sealing the cap 730 over the spout 724 as described above so that a reduced amount CO₂ gas released by the effervescent reaction becomes lost to the atmosphere. In some implementations, to facilitate a fast sealing process for users, the cap may include alignment markers 936 that are radially aligned with the protrusions 932 of the cap 730 to allow users to align the protrusions 932 with the channels 822 of the removable lid 720 by visually aligning the markers 936 with the channel opening 828 of the channels 822, even though the protrusions 932 are disposed on an interior portion of the cap 730.

Those skilled in the art will recognize that the foregoing functionality for quickly sealing the cap 730 over the spout 724 in the manner described provides significant advantages over conventional bottle caps and/or sealing systems. For example, conventional threaded bottle openings and caps interfaces may require users to repeatedly rotate the cap and/or the bottle greater than 360 degrees in order to effectuate a seal between the bottle and the cap, often requiring users to release their grip on the cap, reposition their hand, and re-grip the cap to continue rotating the cap. Thus, if used to create a carbonated beverage according to the present disclosure, conventional threaded bottle openings would cause an increased amount of CO₂ gas released by the effervescent reaction to be lost to the atmosphere while the user engaged the threading process to seal the bottle. In contrast, a user may effectuate a seal between the cap 730 and the spout 724 by inserting the protrusions 932 of the cap 730 through the channels 822, pushing downward on the cap 730, and rotating the cap 730 less than 360 degrees (e.g., 270°, 180°, 90°, or some interval therebetween), which users may accomplish, in many instances, without repositioning their grip on the cap.

As noted above, the first portion 824 of the channels 822 is substantially vertical and the second portion 826 of the channels is substantially horizontal but downward-sloping. However, those skilled in the art will recognize that the particular arrangement, configuration, proportions, and/or dimensions depicted in FIG. 8 is illustrative only, and non-limiting. For instance, rather than dividing the channels 822 into substantially vertical and substantially horizontal sections, in some embodiments, the channels 822 is a curved channel that extends from the upward-facing channel opening 828 to the channel end 832.

As the bottle 700 becomes pressure-sealed with an aqueous solvent and an effervescent composition disposed therein, as described above, the effervescent reaction increases the pressure within the bottle 700. As will be described in more detail hereinafter, the cap 730 may include a pressure relief valve to prevent the pressure within the bottle from reaching unsafe levels (e.g., pressure levels that might cause the bottle to explode or rupture). Furthermore, after the effervescent reaction completes sufficiently to form a carbonated beverage within the bottle 700, the pressure within the bottle 700 may, in some instances and without appropriate corrective features, be high enough to cause the cap 730 to become forced off of the removable lid 720 in an uncontrolled fashion as a user withdraws the cap 730 from the removable lid 720 (e.g., by withdrawing the protrusions 932 of the cap through the channels 822). Accordingly, there exists a need to provide features that allow users to safely remove the cap 730 from the removable lid 720 when the bottle is pressurized to enable users to access the carbonated beverage formed within the bottle 700.

Accordingly, referring again to FIG. 7C, the second portion 826 of the channels 822 may include an indented section 836. As illustrated, the indented section 836 is formed in an upper channel wall 838 of the second portion 826. When the pressure within the bottle 700 is sufficiently high, the pressure within the bottle 700 may exert an upward force on the cap 730, causing the protrusions 932 of the cap to be pressed upward against the upper channel wall 838 of the channels 822. The aforementioned upward force persists against the cap 730 as the user retracts the protrusions 932 along the second portion 826 of the channels 822. As a user rotates the cap 730 to retract the protrusions 932 through the second portion 826 of the channels 822 and over the indented section 836, the upward force (caused by the pressure within the bottle 700) exerted on the cap 730 may force the protrusions 932 upward into the indented section 836. In this regard, the indented section 836 may catch the protrusions 932 of the cap 730 as the protrusions 932 retract through the channels 822 along the upper channel wall 838 of the second portion 826. When the protrusions 932 are positioned within the indented section 836 of the channels 822, the airtight interface between the seals 834, 934 of the removable lid 720 and the cap 730, respectively, may be released to relieve at least some of the pressure from within the bottle 700. While the pressure is relieved, the cap 730 safely refrains from departing from the removable lid 720 because the protrusions 932 are held in place by the indented section 836 of the channels 822.

The protrusions 932 may remain within the indented section 836 of the channels 822 until the pressure within the bottle 700 is sufficiently relieved to allow the cap 730 to be withdrawn from the removable lid 720 in a safe, controlled manner. For example, the pressure within the bottle 700 may be sufficiently reduced such that the upward force on the cap 730 (if still present) is insufficient to force the protrusions 932 into the indented section 836 of the channels 822, allowing the protrusions 932 to fall out of the indented section 836 of the channels 822 for a user to continue to withdraw the protrusions 932 from the channels 822 to remove the cap 730 from the removable lid 720. In another example, a user may apply sufficient downward force on the cap 730 to remove the protrusions 932 from the indented section 836 of the channels 822, allowing the user to continue to withdraw the protrusions 932 from the channels 822 to remove the cap 730 from the removable lid 720.

In the embodiment(s) depicted in FIGS. 7A-7C, the indented section 836 includes a ramp 840 that extends from a part of the upper channel wall 838 and slopes upward toward a first wall 842. The first wall 842 is substantially horizontal and extends from the ramp toward a second wall 844. The second wall 844 is substantially vertical extends from the first wall 842 toward another part of the upper channel wall 838. The first wall 842 and/or the second wall 844 are thus configured to catch the protrusions 932 as the protrusions 932 retract along the upper channel wall 838 through the second portion 826 of the channels 822. Those skilled in the art will appreciate that the particular form, dimensions, proportions, and/or configuration of the indented section 836 shown in FIGS. 7A-7C may be varied within the scope of this disclosure. By way of non-limiting example, the indented section 836 may be implemented as a curved and/or rounded indent in the upper channel wall 838 with a size that corresponds to the size of the protrusions 932. The indented section 836 may alternatively be defined as a portion of the channel having a larger diameter than the flanking upstream and downstream portions of the channel. The indented section 836 can be sized and shaped to receive the protrusion of the cap and to prevent movement along the channel toward the channel bend and/or channel opening without first being depressed below the wall transverse to the channel length that forms part of the indented section.

Attention is now directed to FIG. 9, which illustrates a close-up cross-sectional view of the bottle 700 with the removable lid 720 threaded into the bottle cavity 710 and with the cap 730 sealed over the spout 724 of the removable lid 720. As mentioned above, additional details concerning the airtight connection between the removable lid 720 and the cavity opening 716 will now be described.

As shown in FIG. 9, the cavity opening 716 includes a flat annular rim 1012 that extends around the top of the cavity opening 716. The cavity opening 716 also includes an angled surface 1014 that extends around the cavity opening 716 and from an interior side of the rim 1012. The angled surface 1014 slopes downward toward the interior sidewall 712 of the bottle cavity 710. The removable lid 720 may include a gasket that is shaped to extend circumferentially around the removable lid 720 and to interface with both the rim 1012 and the angled surface 1014 at the cavity opening 716. In some instances, as shown in FIG. 10, the gasket is configured to reside within a gasket channel 1016 of the removable lid 720 that is formed around the removable lid 720 between a radial protrusion 1018 and a shelf 1020. The radial protrusion 1018 extends radially from and surrounds the removable lid 720, and the shelf 1020 opposes the radial protrusion 1018 and also surrounds the removable lid 720. The shelf 1020 has an outer diameter that is smaller than the outer diameter of the radial protrusion 1018.

With the gasket positioned within gasket channel 1016, the gasket may interface with both the rim 1012 and the angled surface 1014 to form an airtight connection between the removable lid 720 and the cavity opening 716 of the bottle cavity 710. In some implementations, providing an angled surface 1014 for interfacing with the gasket in addition to or as an alternative to a flat annular rim 1012 enables the gasket to interface with a greater surface area, as compared with conventional gasket configurations in which a gasket interfaces only with a flat rim that extends between interior and exterior sidewalls of a bottle. Providing a gasket configuration that with a large contact area between the gasket and the cavity opening 716 may, in some implementations, enable the bottle 700 to remain pressure-sealed even when the pressure within the bottle 700 reaches high levels (e.g., greater than 100 psi, preferably greater than 50-60 psi).

It should be noted that the shelf 1020 need not be included in all embodiments, so long as the gasket is securable to either the removable lid 720 or the bottle cavity 710. Additionally, it should be noted that, in some embodiments, the gasket may also extend at least partially over and contact the interior sidewall 712 when the removable lid 720 is threaded into the bottle cavity 710 to increase the contact area between the gasket and the bottle cavity 710. Furthermore, in yet other embodiments, the cavity opening 716 includes no flat annular rim 1012 and only includes an angled surface 1014 extending between an exterior sidewall of the bottle cavity and the interior sidewall 712 thereof.

FIG. 9 further illustrates that the cap 730 includes a pressure relief valve 1030. The pressure relief valve 1030 is configured to selectively open to release pressure from the bottle 700 when the pressure within the bottle 700 meets or exceeds a threshold pressure (e.g., 100 psi, preferably 50-60 psi).

Conventional pressure relief valves for use in commercially available drinking bottles include a simple flexible silicone diaphragm element that is disposed over/around a pressure relief opening of a bottle and is configured to warp in response to increased pressure to release pressure through the pressure relief opening. A simple flexible silicone diaphragm configuration may be desirable for commercial drinking bottles because of the small number of parts and/or low materials/manufacturing costs associated with flexible silicone diaphragms. However, in many instances, flexible silicone diaphragm configurations may fail to withstand high pressures associated with creating a carbonated beverage, according to the present disclosure (e.g., up to 100 psi, preferably about 50-60 psi). Furthermore, flexible silicone diaphragms may be difficult to calibrate to relieve pressure at a specific, predetermined threshold pressure.

Accordingly, FIG. 10 illustrates that the pressure relief valve 1030 may be implemented as a spring-loaded pressure relief valve, in contrast with conventional pressure relief valves of commercial drinking bottles. A spring-loaded pressure relief valve may provide a pressure relief valve that is configurable to reliably relieve pressure from the bottle 700 at precise, high threshold pressure values. The pressure relief valve 1030 includes a diaphragm 1032 that is positioned over a pressure relief opening 1034 of the cap 730 (e.g., from the outside of the cap 730). The diaphragm 1032 may form an airtight seal over the pressure relief opening 1034 when the pressure within the bottle 700 does not meet or exceed the threshold pressure. The pressure relief valve 1030, as shown, also includes an extension portion or elongate body 1036 that extends from the diaphragm 1032 through the pressure relief opening 1034 to the inside of the cap 730 (e.g., to a side of the pressure relief opening 1034 that is opposite to the diaphragm 1032). One will recognize that the extension portion or elongate body 1036 may be integrally formed with or otherwise connected to the diaphragm 1032 in any manner known in the art, such as by ultrasonic welding. It should also be appreciated that the diaphragm may be a separate component that is compressed over the vent opening by a proximal flange coupled to the extension portion/elongate body 1036.

The extension portion or elongate body 1036 may extend and affix to a spring retainer 1038 (e.g., by ultrasonic welding or by being integrally formed therewith) such that a spring 1025 may be positioned circumferentially around the extension portion or elongate body 1036 and be held in place and biased between the spring retainer 1038 and an interior portion of the cap 730 that surrounds the pressure relief opening 1034. The spring 1025 may, accordingly, be configured to hold the diaphragm 1032 in an airtight manner over the pressure relief opening 1034 as long as the pressure within the bottle 700 does not meet or exceed the threshold pressure. Put differently, the spring 1025 may hold the diaphragm 1032 toward the pressure relief opening 1034 with a force that is equal to or less than a force exerted on the diaphragm when the pressure within the bottle 700 meets or exceeds the threshold pressure.

Although the pressure relief valve 1030 shown in FIG. 9 is depicted as being positioned centrally in a top portion of the cap 730, those skilled in the art will recognize that the depicted placement is illustrative only and non-limiting. Additionally, it will be appreciated that the design of the pressure relief valve 1030 embodiment(s) shown and described with reference to FIG. 9 may be varied within the scope of this disclosure. For example, the extension portion or elongate body 1036 may connect with the diaphragm and/or the spring retainer with a threaded or otherwise adjustable connection, allowing the threshold pressure for relieving pressure within the bottle 700 with the pressure relief valve 1030 to be adjusted.

### Exemplary Effervescent Compositions for Making a Carbonated Beverage

Attention will now be directed to effervescent compositions described herein. A typical reaction of an effervescent composition is the reaction between an acidic compound and a carbonate or bicarbonate salt, which forms CO₂ gas (e.g., 2H⁺+CO₃²⁻→H₂O+CO₂). Accordingly, an effervescent composition will include least one acidic component and carbonate or bicarbonate salt (or a mixture of carbonate and bicarbonate salts). The use of carbonate and/or bicarbonate salts, however, can result in a saline taste in the aqueous solution in which the effervescent reaction occurred. Conventional approaches for ameliorating the saline taste include reducing salt levels in the effervescent composition as much as possible.

In contrast, at least some embodiments disclosed herein involve effervescent compositions that include a surprisingly high amount of metals/carbonates. The use of high levels of metals/carbonates in the effervescent composition creates more carbonation when the effervescent composition reacts with an aqueous solvent in a pressurized environment. In some instances, the additional carbonation operates to mask the salinity of the resulting carbonated beverage (e.g., the carbonated beverage that results after the reaction between the effervescent composition and the beverage). Furthermore, in some implementations, adding higher than normal levels of acids (e.g., citric acid and/or malic acid) to react with the increased levels of metals/carbonates also serves to mask the salinity of the final carbonated beverage.

Effervescent compositions of the present disclosure include a mix of acidic and basic components that when combined in an aqueous solution undergo a carbonation reaction. The compositions disclosed herein include between 35%-80% by weight acid salts, preferably 41%-64% by weight acid salts, and 25%-51% by weight carbonate/bicarbonate salts, preferably 33%-42% by weight carbonate/bicarbonate salts. In a preferred embodiment, the carbonate/bicarbonate salts include between 5%-8% by weight calcium carbonate having a particle size of less than 0.1 μm, preferably between 0.5 μm-0.8 μm.

The acid salts can include any acid such as citrus acid, malic acid, and/or ascorbic acid (vitamin C). In a preferred embodiment citric acid is included in the composition at a concentration of between 30%-40% by weight, preferably 30%-35% by weight, of the total composition. The citric acid can be size excluded to a particle size of between 170 mesh-120 mesh. In combination with the calcium carbonate particles, the carbonation reaction can be productive while surprisingly not creating a metallic or unnatural aftertaste.

In some embodiments, the effervescent compositions disclosed herein include <15% natural flavorings and sweeteners. In a preferred embodiment, the effervescent compositions include less than 2% by weight or between 1%-2% by weight sweetener and up to about 10% by weight of natural flavors, preferably between 2%-8% fruit extracts. As such, the compositions disclosed herein do not strive to artificially sweeten or otherwise mask a distasteful reactant. Rather, the compositions disclosed herein can beneficially highlight the natural flavors within the mix without an artificial or synthetic taste typically associated with carbonation reactions.

In some embodiments, the effervescent compositions disclosed herein include less than 2% by weight, preferably between 0.05%-1% of an anticaking agent to improve flowability of the composition.

In some embodiments, the effervescent compositions can additionally, and in some instances optionally, include <2.5% by weight of vitamin supplements, such as B vitamins, vitamin C, and/or vitamin D Additional supplements such as caffeine and caffeine derivatives can be included at the desired concentration (e.g., less than 300 mg total caffeine (equivalent) content, preferably between 80 mg-160 mg).

It should be appreciated that in some embodiments, the compositions can additionally (and optionally) include <4% by weight of excipients (e.g., gum acacia), when appropriate, to balance the total compositional weight. As a non-limiting example, the total compositional weight for flavoring and carbonating 20 fluid ounces of water using an effervescent composition disclosed herein is between 7.75-8.25 gram, preferably about 8 grams.

Tables 1-5 below illustrate exemplary effervescent compositions that may be utilized to make a carbonated beverage, according to the present disclosure:

TABLE 1

| | Amount |
|---|---|
| Ingredient | (% weight composition) |
| Acidic component | 41%-64% |
| Carbonate/bicarbonate salts | 25%-51% |
| Natural flavoring/sweeteners | <15% |
| Anticaking agent | 0.05%-1% |
| Vitamin supplement (optional) | <2.5% |
| Excipient (optional) | 1.5%-3.5% |

TABLE 2

| | Amount |
|---|---|
| Ingredient | (% weight composition) |
| Acidic component | 41%-64% |
| Calcium carbonate | 4%-10% |
| (particle size <1 μm) | |
| Bicarbonate salts | 21%-41% |
| Natural flavoring/sweeteners | <15% |
| Anticaking agent | 0.05%-1% |
| Vitamin supplement (optional) | <2.5% |
| Excipient (optional) | 1.5%-3.5% |

TABLE 3

| | Amount |
|---|---|
| Ingredient | (% weight composition) |
| Citric acid | 30%-35% |
| Malic acid | 18%-22% |
| Calcium carbonate | 5%-8% |
| (particle size 0.5 μm-0.8 μm) | |
| Bicarbonate salts | 28%-35% |
| Fruit extracts | 2%-8% |
| Sweetener | 1%-3% |
| Anticaking agent | 0.05%-1% |
| Vitamin C supplement | <2.2% |
| Vitamin D supplement | 0.1%-0.3% |

TABLE 4

| | Amount | |
|---|---|---|
| | (% weight | Particle Size Range (US |
| Ingredient | composition) | Mesh Screen or μm) |
| Citric acid | 30%-35% | #170-#120 |
| Malic acid | 18%-22% | #100-#25 |
| Calcium carbonate | 5%-8% | 0.5 μm-0.8 μm |
| Potassium bicarbonate | 14%-17% | N/A |
| Sodium bicarbonate | 14%-17% | #100-#25 |
| Fruit extracts | 2%-8% | N/A |
| Sweetener | 1%-3% | N/A |
| Anticaking agent | 0.05%-1% | N/A |
| Vitamin C supplement | <2.2% | #25-#14 |
| Vitamin D supplement | 0.1%-0.3% | N/A |

TABLE 5

| | Amount | |
|---|---|---|
| | (% weight | Particle Size Range (US |
| Ingredient | composition) | Mesh Screen or μm) |
| Citric Acid | 35%-45% | #120-#170 |
| Malic Acid | 5%-15% | #100-#25 |
| Ascorbic Acid | 1%-3% | #14-#25 |
| Calcium Carbonate | 8%-12% | 0.5 μm-0.8 μm |
| Potassium Bicarbonate | 5%-15% | #70-#100 |
| Magnesium Carbonate | 2-4% | #270-#325 |
| Sodium Bicarbonate | 10%-20% | #50-#70 |
| Natural Flavoring | 1%-2.5% | #80-#120 |
| Natural Sweetener Blend | 0.5%-5% | #45-#120 |
| Excipient (Gum Acacia) | <4% | #50-#70 |

Accordingly, at least some effervescent compositions of the present disclosure include at least one acidic component, at least one carbonate or bicarbonate salt, one or more sweeteners or flavors, and an excipient. A number of specific exemplary effervescent compositions will now be discussed.

Those skilled in the art will appreciate that the foregoing examples and tables depicting effervescent compositions are exemplary only and that other ingredients/compounds may be used in combination with or as substitutes for any of the foregoing ingredients. For example, an effervescent composition can include tartaric acid, fumaric acid, adipic acid, succinic acid, acid anhydrides, and/or any combination of any of the foregoing as acidic components. Furthermore, an effervescent composition can include sodium carbonate anhydrous, potassium carbonate, sodium glycine carbonate, L-lysine carbonate, arginine carbonate, and/or any combination of any of foregoing as carbonate or bicarbonate salts. Additionally, an effervescent composition can include sorbitol, mannitol, a polymer binder, a sugar, a soluble starch derivative, an alcohol sugar, any fruit/plant extract or blend, and/or any combination of any of the foregoing as excipients and/or sweeteners.

### Methods for Making a Carbonated Beverage

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

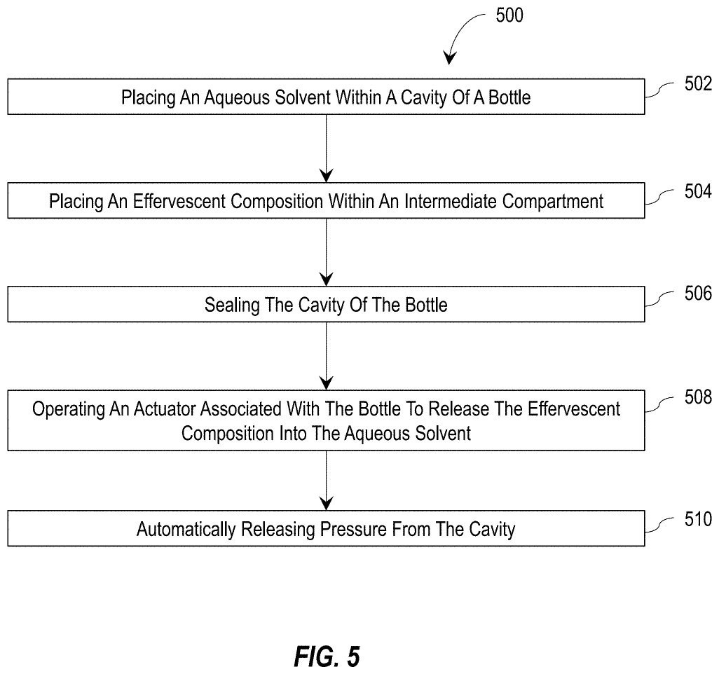

FIG. 5 shows a flow diagram 500 depicting acts of methods associated with making a carbonated beverage in a manner that includes a bottle (e.g., bottles shown and described with respect to FIG. 1-4) and an effervescent composition. In particular, the illustrated flow diagram 500 includes acts of placing an aqueous solvent within a cavity of a bottle (act 502), placing an effervescent composition within an intermediate compartment (act 504), sealing the cavity of the bottle (act 506), operating an actuator associated with the bottle to release the effervescent composition into the aqueous solvent (act 508), and automatically releasing pressure from the cavity (act 510).

As noted above, act 502 includes placing an aqueous solvent within a cavity of a bottle. In some embodiments, the cavity of the bottle is at least partially surrounded by an insulating layer (e.g., a vacuum-sealed insulating layer). In some embodiments, the aqueous solvent is a beverage that a user wishes to flavor and carbonate, such as water, juice, tea, coffee, alcoholic drinks, or any other beverage. The aqueous solvent will react with an effervescent composition to create CO₂ gas and thereby carbonate the beverage.

Act 504 includes placing an effervescent composition within an intermediate compartment. The effervescent composition may correspond to any effervescent composition (or combination of effervescent compositions) described hereinabove. For example, in some embodiments, the effervescent composition includes 41%-64% of an acidic component, 25%-51% of carbonate or bicarbonate salts, 5%-7.5% of one or more sweeteners or flavors, and 1.5%-3.5% of an excipient. Additionally, in some instances, the acidic component comprises 35%-45% citric acid, 5%-15% malic acid, and 1%-3% ascorbic acid, the carbonate or bicarbonate salts comprises 8%-12% calcium carbonate, 2%-4% magnesium carbonate, 5%-15% potassium bicarbonate, and 10%-20% sodium bicarbonate, the one or more sweeteners or flavors include 1.5%-2.5% of a fruit extract, 0.5%-4.5% natural sweetener blend, and the excipient comprises 1.5%-3.5% gum acacia. Other compositions are disclosed above.

In some instances, the intermediate compartment is a component of a removable lid of the bottle. The intermediate compartment is accessible, for example, from a bottom portion of the removable lid by displacing a barrier (e.g., a physical wall) of the removable compartment. In some embodiments, the barrier is manually displaced or mechanically displaced by operating an actuator (e.g., a button) of the removable lid. For example, by displacing a barrier of the intermediate compartment, a user may place the effervescent composition within the intermediate compartment and then re-close the intermediate compartment such that the effervescent composition becomes secured within the intermediate compartment.

Act 506 includes sealing the cavity of the bottle. In some embodiments, act 506 involves securing a removable lid of the bottle over an opening of the cavity of the bottle (e.g., by threading the removable lid into corresponding threads on the opening of the cavity). One or more gaskets or other elements may be used so that the cavity of the bottle becomes pressure-sealed when the removable lid is secured over the cavity of the bottle. Upon sealing the removable lid to the bottle, in some embodiments, the movable barrier of the intermediate compartment of the removable lid is positioned over the cavity of the bottle, such that the effervescent composition positioned within the intermediate compartment will be released into the cavity if the movable barrier is displaced sufficiently.

Act 508 includes operating an actuator associated with the bottle to release the effervescent composition into the aqueous solvent. In some embodiments, the actuator is a button for mechanically displacing the barrier of the intermediate compartment to selectively open the intermediate compartment to the cavity of the bottle. Upon selectively opening the intermediate compartment to the cavity, the effervescent composition that was disposed within the intermediate compartment falls or is released into the aqueous solvent that was placed within the cavity.

In an alternative embodiment, the effervescent composition is added to a sleeve or other insert and when the bottle is sealed, the aqueous solution can be brought into contact with the effervescent composition. This can be done, for example, by shaking the bottle, which would cause the composition to discharge into the aqueous solution and/or allow the aqueous solution to interact with the effervescent composition (e.g., by filling an open-toped insert and/or passing through the water-permeable sidewalls of the insert). As a non-specific example, the method can include opening a stick pack comprising the effervescent composition, pouring the contents into a depression on a plastic or silicone ring-shaped insert located near the mouth of the container, closing the lid, and shaking the cup for a period of time (e.g., 15 seconds) that would allow the reactants of the effervescent composition to be fully or at least almost entirely mixed with the aqueous solvent.

Accordingly, the effervescent composition begins to react with the aqueous solvent, forming and releasing CO₂ gas. Because the release of the effervescent composition into the aqueous solvent occurs in an airtight environment, the reaction between the effervescent composition and the aqueous solvent increases the pressure within the cavity of the bottle (e.g., the CO₂ gas released as a result of the chemical reaction facilitated by the solvent and the ingredients within the effervescent composition causes an increase in the pressure of the bottle). Because of the pressurized environment, at least a portion of the CO₂ gas dissolves into the aqueous solvent, carbonating the aqueous solvent (e.g., creating a carbonated beverage). Those skilled in the art will recognize that, in some instances, improved carbonation results are achieved by first cooling the aqueous solvent and utilizing a bottle with an insulated cavity.

Act 510 includes automatically releasing pressure from the cavity. Because the pressure in the cavity of the bottle increases as the effervescent composition reacts with the aqueous solvent, the bottle may include a pressure relief valve (e.g., as part of the cavity of the bottle or the removable lid of the bottle) for releasing pressure from the cavity when the pressure within the cavity exceeds a threshold pressure.

Referring now to FIG. 10, illustrated is another flow diagram 1100 depicting acts of methods associated with making a carbonated beverage in a manner that includes a bottle (e.g., the bottles depicted and described with respect to FIG. 6-9) and an effervescent composition, such as any of those described above. In particular, the illustrated flow diagram 1100 includes acts of placing an aqueous solvent within a cavity of a bottle through a cavity opening (act 1102), securing a lid over the cavity opening, the lid comprising a spout (act 1104), placing an effervescent composition into the cavity of the bottle through the spout (act 1106), sealing the cavity of the bottle by placing a cap over the lid (act 1108), automatically releasing pressure from the cavity (act 1110), and manually releasing pressure from the cavity (act 1112).

As noted above, act 1102 includes placing an aqueous solvent within a cavity of a bottle through a cavity opening. In some embodiments, the cavity of the bottle is at least partially surrounded by an insulating layer (e.g., a vacuum-sealed insulating layer). In some embodiments, the aqueous solvent is a beverage that a user wishes to flavor and carbonate, such as water, milk, juice, tea, coffee, alcoholic drinks, or any other beverage. The aqueous solvent will react with an effervescent composition to create CO₂ gas and thereby carbonate the beverage. The cavity opening may correspond to the cavity opening 716 of the bottle 700 described hereinabove.

It should be noted that the aqueous solvent may be placed within the cavity of the bottle through a spout of a lid positioned over the cavity opening (e.g., lid 720 described herein).

Act 1104 includes securing a lid over the cavity opening, the lid comprising a spout. The lid may correspond to the removable lid 720 described herein with spout 724 extending from the top thereof. The spout may have a diameter that is smaller than the diameter of the cavity opening. The lid may form a pressure-tight seal over the cavity opening. In some instances, the removable lid includes a gasket that interfaces with both a flat surface and an angled surface at the cavity opening.

Act 1106 includes placing an effervescent composition into the cavity of the bottle through the spout (e.g., the spout 724 of the removable lid 720). The effervescent composition may correspond to any effervescent composition (or combination of effervescent compositions) described hereinabove, such as an effervescent powder or tablet. In some embodiments, a user pours an effervescent powder from a package that is sized to fit through the spout. The effervescent composition then may begin to react with the aqueous solvent within the bottle cavity 710 to release CO₂ gas.

Act 1108 includes sealing the cavity of the bottle by placing a cap over the lid. The sealing may be performed in a quick manner as a single motion, in some instances. Securing a cap over the lid may allow the CO₂ gas released by the effervescent reaction to pressurize the cavity of the bottle and dissolve into the aqueous solvent to form a carbonated beverage.

In some embodiments, sealing the cavity of the bottle may include inserting a protrusion of the cap into a channel by inserting the protrusion through a channel opening positioned at a top of the spout, advancing the protrusion through a first portion of the channel toward a channel bend, and advancing the protrusion through the channel bend and through a second portion of the channel toward a channel end (the second portion of the channel may have a downward slope to allow the cap to descend and seal over the spout).

Act 1110 includes automatically releasing pressure from the cavity. In some implementations, the pressure from within the cavity is automatically relieved by a spring-loaded pressure relief valve of the cap when the pressure within the cavity of the bottle meets or exceeds a threshold pressure.

Act 1112 includes manually releasing pressure from the cavity. When a cap with a protrusion was sealed over a lid with a channel that has first and second portions, in the manner described under act 1108, manually releasing pressure from the cavity may include, as the protrusion is forced against an upper channel wall of the second portion by the pressure within the cavity of the bottle, retracting the protrusion through the second portion of the channel over an indented section in the upper channel wall of the section portion. The retraction over the indented section may cause the protrusion of the cap to be forced upward into the indented section. When the indented section is at least partially within the indented section, the cap may at least partially unseal from the spout to release at least some of the pressure within the cavity of the bottle through the spout while retaining the protrusion of the cap within the indented portion.

After at least some of the pressure is released from within the bottle cavity, a user may further remove the protrusion of the cap from the indented section (e.g., by pushing downward on the cap or allowing gravity to pull the cap downward), continue to retract the protrusion through the second portion of the channel toward the channel bend, and retract the protrusion through the channel bend, through the first portion of the channel, and through the channel opening. The carbonated beverage may then be accessed through the spout, or the cavity opening if the lid becomes removed from the bottle.

The disclosed embodiments may, in some instances, provide various advantages over conventional systems, methods, and compositions for creating carbonated beverages, particularly in a non-commercial setting. Some of these advantages include providing users with a highly portable and safe system for turning any beverage into a carbonated beverage, while also eliminating the need for a CO₂ canister, cartridge, or tank.

Although the subject matter described herein is provided in language specific to structural features and/or methodological acts, it is to be understood that the subject matter defined in the appended claims is not necessarily limited to the described features or acts so described. Rather, the described features and acts are disclosed as example forms of implementing the claims.

### CONCLUSION

Unless defined otherwise, all technical and scientific terms used herein have the same meaning as commonly understood by one of ordinary skill in the art to which the present disclosure pertains.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. An effervescent composition for creating a carbonated beverage, comprising:
about 41%-64% by weight of an acidic component;
about 25%-51% by weight of carbonate or bicarbonate salts;
less than about 15% by weight of one or more sweeteners or flavors;
about 0.05%-1% by weight of an anticaking agent; and
optionally less than about 2.5% by weight vitamin supplement,
wherein all weights are based on a total weight of the composition.

2. The effervescent composition of claim 1, wherein the carbonate or bicarbonate salts comprises about 4%-10% by weight calcium carbonate and about 21%-41% by weight of bicarbonate salts, based on the total weight of the composition.

3. The effervescent composition of claim 1, wherein the carbonate or bicarbonate salts comprises about 5%-8% by weight calcium carbonate and about 28%-35% by weight of bicarbonate salts, wherein all weights are based on the total weight of the composition.

4. The effervescent composition of claim 3, wherein the calcium carbonate has a particle size less than 1 μm.

5. The effervescent composition of claim 1, wherein the bicarbonate salts comprise about 14%-17% by weight potassium bicarbonate, and about 13%-26% by weight sodium bicarbonate, based on the total weight of the composition.

6. The effervescent composition of claim 5, wherein the acidic component comprises about 28%-37% by weight citric acid and about 13%-27% by weight malic acid, based on the total weight of the composition.

7. The effervescent composition of claim 6, wherein the citric acid has a particle size between 120-170 mesh.

8. The effervescent composition of claim 6, wherein the one or more sweeteners or flavors comprise between 1%-3% by weight of the sweetener and between 2%-8% by weight of one or more fruit extracts, based on the total weight of the composition.

9. The effervescent composition of claim 8, wherein the anticaking agent comprises about 0.1%-0.25% by weight silicon dioxide, based on the total weight of the composition.

10. The effervescent composition of claim 8, further comprising less than about 2.5% by weight vitamin supplement.

11. The effervescent composition of claim 10, wherein the vitamin supplement comprises about 0.1%-0.3% by weight vitamin D and less than about 2.2% vitamin C, based on the total weight of the composition.

12. The effervescent composition of claim 11, wherein the vitamin C comprises ascorbic acid having a particle size between 25-14 mesh.

13. A system for making a carbonated beverage, comprising:
an effervescent composition according to claim 1; and
a bottle, comprising:
an interior sidewall defining a cavity and a cavity opening;
a removable lid configured to interface with and seal over the cavity opening, the removable lid comprising a spout; and
a cap configured to form an airtight seal over the spout, wherein the bottle is pressure-sealed when the removable lid is sealed over the cavity opening and the cap is sealed over the spout.

14. The system of claim 13, wherein the removable lid comprises a channel formed by an exterior surface of the spout, the channel spanning a channel opening, a channel bend, and a channel end, and wherein:
the channel opening is positioned at a top of the spout and is configured to receive a protrusion of the cap and to allow the protrusion to advance from the channel opening to the channel bend; and
the channel extends from the channel bend around at least a portion of the circumference of the spout in a downward-sloping fashion toward the channel end, such that the cap forms an airtight seal over the spout of the removable lid when the protrusion of the cap is advanced past the channel bend and toward the channel end.

15. The system of claim 14, wherein the channel comprises an indented section formed by an upper channel wall between the channel bend and the channel end, the indented section being configured to catch the protrusion of the cap as the protrusion retracts through the channel from the channel end toward the channel bend and is biased toward the upper channel wall.

16. The system of claim 15, wherein the cap includes a pressure relief valve configured to selectively open to release pressure from the bottle when the pressure within the bottle meets or exceeds a threshold pressure, the pressure relief valve comprising:
a proximal flange connected to a distal flange by an elongate body, the elongate body extending through a pressure relief opening formed in the cap and having a smaller diameter than the pressure relief opening;
a diaphragm positioned over the pressure relief opening of the cap and beneath the proximal flange, the diaphragm forming an airtight connection with the cap over the pressure relief opening when the pressure within the bottle is below the threshold pressure; and
a spring arranged circumferentially around the elongate body and biased between the distal flange and an interior sidewall of the cap surrounding the pressure relief opening, the spring having a stiffness calibrated such that below the threshold pressure, the spring biases against the distal flange and causes the proximal flange to compress the diaphragm to form the airtight connection therebetween and at or above the threshold pressure, the spring is compressed between the distal flange and the interior sidewall of the cap surrounding the pressure relief opening at a distance to cause the pressure relief valve to open by extending the proximal flange away from the diaphragm.

17. The system of claim 15, wherein the indented section further comprises:
a ramp section having a steeper slope than the upper channel wall positioned adjacent to and downstream of the ramp section;
a first wall coupled to the ramp section; and
a second wall transverse to—and coupled to—the first wall, the second wall extending downward into the channel and being sized and shaped to (i) catch the protrusion as the protrusion retracts through the channel from the channel end toward the channel bend and is biased toward the upper channel wall, and (ii) allow the protrusion to pass back into the channel proximal of the indented section when the protrusion is biased toward the channel bend and toward a lower channel wall opposite the first wall.

18. A bottle for creating a carbonated beverage by combining an effervescent composition with a liquid disposed within the bottle, the bottle comprising:
an interior sidewall defining a cavity and a cavity opening, wherein the cavity opening has a flat rim extending around a top of the cavity opening and an angled surface extending from an interior side of the flat rim sloping downward toward an interior sidewall of the cavity;
a removable lid configured to interface with and seal over the cavity opening, the removable lid comprising a spout and a gasket configured to interface with both the flat rim and the angled surface of the cavity opening to provide an airtight connection between the removable lid and the cavity, the gasket being positioned circumferentially around of the removable lid within a gasket channel extending around the removable lid, the gasket channel being formed around the removable lid between a radial protrusion extending radially from the removable lid and a shelf that surrounds the removable lid and opposes the radial protrusion; and
a cap configured to form an airtight seal over the spout, wherein the bottle is pressure-sealed when the removable lid is sealed over the cavity opening and when the cap is sealed over the spout.

19. The bottle of claim 18, wherein the shelf has an outer diameter that is smaller than an outer diameter of the radial protrusion.

20. The bottle of claim 19, wherein the removable lid comprises a channel formed by an exterior surface of the spout, the channel spanning a channel opening, a channel bend, and a channel end, and wherein:
the channel opening is positioned at a top of the spout and is configured to receive a protrusion of the cap and to allow the protrusion to advance from the channel opening to the channel bend; and
the channel extends from the channel bend around at least a portion of the circumference of the spout in a downward-sloping fashion toward the channel end, such that the cap forms an airtight seal over the spout of the removable lid when the protrusion of the cap is advanced past the channel bend and toward the channel end.
